(19) United States
(12) Patent Application Publication
(10) Pub. No.: US 2026/0288306 A1
(43) Pub. Date: Sep. 24, 2026

(54) DISPLAYING COMMUTING INFORMATION ASSOCIATED WITH MULTIPLE POINTS OF INTEREST USING A HEATMAP-LIKE DISPLAY

(71) Applicant: MUSTWANTS, INC., St. Augustine, FL (US)

(72) Inventors: Zachary STAUFFER, St. Augustine, FL (US); Scott HAYFORD, St. Augustine, FL (US)

(21) Appl. No.: 19/571,937

(22) Filed: Mar. 19, 2026

Related U.S. Application Data
(60) Provisional application No. 63/774,358, filed on Mar. 19, 2025.

(51) Int. Cl. G06F 3/0482; G06F 16/903; G06F 16/909; G06Q 50/16

(52) U.S. Cl. CPC G06F 3/0482; G06F 16/90335; G06F 16/909; G06Q 50/16

(57) ABSTRACT

According to an embodiment, an automated prioritization and organization system is described, which aids in identifying and defining personal preferences by using specific attributes indicated by the user and optionally fused with user-defined collaborators' preferences, weighted by additional intrinsic data selected by the user to generate lists of prioritized products and/or services. A heat map-like display can be underlaid relative to icons associated with locations of the prioritized products and/or services to show average commute times relative to multiple points of interest.

### TECHNICAL FIELD

Some embodiments of the subject matter disclosed herein relate to computer-implemented methods and systems for generating, analyzing, and displaying commute-related information associated with multiple points of interest using interactive, map-based visualizations such as heatmap-style overlays. Certain embodiments involve receiving user-defined locations, incorporating time-related constraints, and dynamically generating visual representations that convey geographic relationships, travel burdens, and proximity considerations across multiple locations of interest.

### BACKGROUND

In many cases, online purchasers of goods and services are overwhelmed with the vast number of choices of goods and services that they are interested in purchasing, or even just learning about. Compounding that problem is the fact that there are no standardized ways to portray information about goods and services that are available and, therefore, different vendors portray similar (or even the same) goods and services quite differently. In some cases, goods and services are desired to be purchased locally, and thus geo-location of a user's cellphone (or similar device) can become part of the process of searching for goods and services. Accordingly, the following discussion will begin with a discussion of geo-location, and then return to the challenges of organizing and prioritizing data sets associated with desired goods and services.

Accurately determining the geographic position of a mobile user within a wireless communication network is an ongoing challenge in wireless telecommunications development. Government mandates, such as the E-911 positioning requirements in North America, and commercial Location Based Services (LBS) demand rapid and accurate position determination for user equipment (UE). Determining a location of user equipment is frequently referred to as “positioning” in the radiocommunication art. The accurate positioning of a UE becomes more challenging when considering indoor scenarios where, for example, Assisted GPS signals are less detectable.

Several position determination methods, of varying accuracy and complexity, are known in the art. These include cell ID positioning, Round Trip Timing (RTT) positioning, Observed Time Difference of Arrival (OTDOA) positioning, Assisted Global Positioning System (A-GPS) positioning, and fingerprinting positioning. Some of these positioning techniques will now be described in more detail.

For example, Assisted GPS (A-GPS) positioning is an enhancement of the Global Positioning System (GPS), an exemplary architecture 100 of which is illustrated in FIG. 1. Local GPS reference receiver networks/Global reference receiver networks collect assistance data from GPS satellites, such as ephemeris data. The assistance data, when transmitted to GPS receivers in UEs connected to the cellular communication system, enhance the performance of the UE GPS receivers. Typically, A-GPS accuracy can become as good as plus or minus ten meters without differential operation. However, this accuracy becomes worse in dense urban areas and indoors, where the sensitivity of the GPS receivers in UEs is often not high enough for detection of the relatively weak signals transmitted from the GPS satellites.

Regardless of which technology is used to locate a user's mobile device, the resulting location information is available for commercial and government usage. For example, various location-tracking applications (“apps”) are currently available to source a device's location to other apps, e.g., location tracking apps such as Google Latitude, Find My Friends, Nearby, and Pathshare. Such location-tracking apps return, e.g., the longitude, latitude, and optionally a confidence indicator (indicating a likelihood that a device is actually within a certain area around the identified coordinates), to other apps which then use that location information in various ways. For example, local mobile search apps can use this location data to enable users to search for businesses, events, and products which are near to their current location.

An example of such a local mobile search app is Around Me. As shown in FIGS. 2(a)-2(d), the Around Me app provides a tool for users to locate local service and product providers. Once the Around Me app is launched, the user can allow the app to use his or her current location. Using this location, a user can search the area around his or her locale for a range of things, from hospitals to movie theaters, and retail stores to bars and restaurants, using a list-based interface 200 displayed on a user's mobile device, an example of which is shown in FIG. 2(a). Tapping on a category in the Around Me app's interface 200, e.g., “Bars” 202, returns a list of places within that category which are local to the user's current location, e.g., list 204 shown in FIG. 2(b).

From the list interface 204 shown in FIG. 2(b), a user can find even more information about a particular establishment by tapping on a corresponding entry. For example, by tapping on the “White Horse Tavern” entry 206, the app can generate another user interface screen 208 as shown in FIG. 2(c). Therein, the establishment's address and phone number are available, as are capabilities to share the information using various social media outlets, to show a route between the user's current location and the establishment, and to add the establishment as a favorite. Returning to FIG. 2(b), the user also has the option of viewing the list of entries in a map view by tapping on map button 210. This results in the app displaying a map view 212 shown in FIG. 2(d). Therein, each of the list entries from FIG. 2(b) is represented by a pin on the map 212. Tapping one of these pins brings up its details as represented by balloon box 214 in FIG. 2(d).

Apps like Around Me provide users with valuable information about their local product and service providers, which takes advantage of location data available from today's networks to inform a user of businesses and services that are available in his or her current location area. However, such apps are also relatively static in nature, e.g., providing static information about a business—like business address and phone number, and they also typically provide little more information than that which is available from web-based services like Google Maps. Moreover, even the static information presented by such apps can be unreliable since the business owners aren't involved in updating the information and because it is difficult for the individual or company which maintains the local mobile search app to continuously and rigorously update a very large database of static local business information.

In addition to the location of the goods or services, users or purchasers may consider multiple other criteria when gathering and organizing information to be used to decide on the purchase of a good or service. Such criteria can include actual features of the product, colors, design, attributes, sizes, location, distances, shapes, amenities, local attributes, lifestyle preferences, and many other criteria as defined by the purchaser. Additional aspects include emotion, feelings, preferences, and other factors tied to partners, spouses, children, and relatives. The challenge for the purchaser to apply these criteria to a purchasing decision-making process is, in many cases, related to the sellers of the relevant goods or services who market their goods or services using methods that obscure aspects of the goods or services or create so many options as to create a confusing market.

The amount of information available to purchasers online is vast and largely unorganized, and the types of inputs, outputs, and tools that are available to organize purchasing data vary wildly from application to application. For example, users can favorite informational items in some applications, in other applications users can identify and save informational items for later selection, and still other applications allow user provision of or review of feedback associated with items that are available for purchase. Additional features in some applications allow sellers or agents to advise the user of the application based on preferences indicated by the user and the prioritization of the good or service being sought by the user.

Various aspects of location-based systems that overcome these and other drawbacks are described in U.S. Pat. No. 12,041,649 to MUSTWANTS INC. (hereafter the '649 patent). Among other types of goods and services that can be organized and prioritized using the embodiments described therein are real estate goods and services, e.g., homes for sale that can be identified, organized, and prioritized based on a given user's or users' preferences. One consideration that most home purchasers evaluate as part of their home-buying search is commuting time or distance, e.g., to and from their place of work. Thus, providing commuting-time information as part of the identification, organization, and prioritization of potential home-purchase options (among other activities to be described below) may be useful to some users of the systems and methods described therein. Commuting time or distance can, for example, be approximately determined based on the map overlay provided in the '649 patent, among other aspects disclosed therein. Another solution to providing commuting times in real estate applications is provided by the Realtor.com® commute filter tool, an example of which is shown in the filter screen 220 of FIG. 2(e). However, among other drawbacks (discussed in more detail below), the commuting tool shown in FIG. 2(e) only provides for a single commute filter associated with a single location (i.e., if a single user buys a particular house, how long will his or her commute to a single work location be). Instead, it would be desirable to provide a visualization tool that facilitates commuting associated with multiple locations of interest and/or multiple people of interest.

As one illustrative example, relocating individuals (e.g., military families, corporate transferees, or others evaluating potential new residences) often need to understand commute times to multiple locations of interest, including workplaces, schools, medical facilities, and other essential services. Traditional commute-planning tools typically require users to manually check each location separately, evaluate traffic patterns, and estimate travel durations, making it difficult to compare options efficiently. These challenges reflect a broader need for systems that can dynamically visualize and prioritize multiple commute paths and user-defined points of interest.

Accordingly, it would be desirable to create location-based systems, devices, methods, and software applications that overcome these and other drawbacks and problems.

This Background section is provided for context and does not constitute an admission that any described technique, system or challenge is prior art under applicable law.

### SUMMARY

According to an embodiment, a system includes a user device including an interface for entering information associated with a plurality of preference criteria associated with a good or service, wherein each preference criterion indicates at least one degree of importance that a user assigns to a corresponding attribute of the good or service. The system further includes a server configured to store and process the plurality of preference criteria and to search electronic records for relevant items using the stored plurality of preference criteria. The server also determines, for each relevant item, a score for each corresponding attribute based on the electronic records, and generates a prioritized list of the relevant items using at least one ranking algorithm. The prioritized list is generated based at least in part on a composite score for each relevant item. Icons associated with the prioritized list are displayed on the user device overlaid on a graphical representation in which geographic regions are visually encoded according to commuting time or distance values relative to a plurality of points of interest.

According to another embodiment, a system includes a first user device having an interface for entering information associated with a plurality of geographic points of interest. The system further includes a server configured to receive, store, and process the plurality of geographic points of interest to determine a first geographic locus having houses for sale or rent that are within a first predetermined commuting time or distance value of all of the plurality of geographic points of interest. The houses for sale or rent may be selected according to predetermined criteria input into the first user device and communicated wirelessly to the server. The server sends map data associated with the first geographic locus to the first user device for display thereon, and the first geographic locus is displayed on the user device overlaid on a graphical representation of a region of interest within which the houses for sale or rent are located.

According to an embodiment, a method includes onboarding a plurality of preference criteria associated with a good or service, wherein each preference criterion indicates at least one degree of importance that a user assigns to a corresponding attribute of the good or service. The method further includes storing, by a server, the plurality of preference criteria; searching electronic records for relevant items associated with the good or service using the stored plurality of preference criteria; determining, for each relevant item, a score for each corresponding attribute using the electronic records; and generating a prioritized list of the relevant items using at least one ranking algorithm. Icons associated with the prioritized list are displayed on a user device overlaid on a graphical representation in which geographic regions are visually encoded according to commuting time or distance values relative to a plurality of points of interest.

According to another embodiment, a method includes receiving, at a server from a first user device, information associated with a plurality of geographic points of interest; storing, by the server, the plurality of geographic points of interest; determining, by the server, a first geographic locus having houses for sale or rent that are within a first predetermined commuting time or distance value of all of the plurality of geographic points of interest; selecting, by the server, the houses for sale or rent according to predetermined criteria input into the first user device and communicated wirelessly to the server; sending, by the server to the first user device via wireless communication signals, map data associated with the first geographic locus; and displaying, on the first user device, the first geographic locus overlaid on a graphical representation of a region of interest within which the houses for sale or rent are located.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts a radiocommunication system;

FIGS. 2A-2E illustrate various user interface screens associated with conventional local mobile search applications;

FIG. 3 illustrates a prioritization and organization system for goods and services according to a generalized embodiment;

FIG. 4 shows another prioritization and organization system for real estate goods and services according to an embodiment;

FIGS. 5A-5U depict various user interface screens associated with a client application associated with a prioritization and organization system for real estate goods and services according to an embodiment;

FIGS. 6A-6E show various other user interface screens associated with a client application associated with a prioritization and organization system for real estate goods and services according to an embodiment;

FIG. 7 is a flowchart illustrating a method according to an embodiment;

FIGS. 8A-8D depict other user interface screens associated with other embodiments, and FIGS. 8E-8O show embodiments associated with providing commuter heat maps.

FIGS. 9A-9B are flowcharts illustrating methods according to embodiments.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment”, “an embodiment”, “some embodiments”, “other embodiments”, “certain embodiments”, “a certain implementation”, or the like, means that a particular feature, structure or characteristic described in connection with an embodiment is included in at least one embodiment of the subject matter disclosed. Thus, the appearance of the phrases “in one embodiment”, “in an embodiment”, “in some embodiments”, “in other embodiments”, “in certain embodiments”, “in a certain implementation”, or the like in various places throughout the specification is not necessarily referring to the same embodiment. Further, the particular features, structures or characteristics may be combined in any suitable manner in one or more embodiments.

As mentioned above, when implementing, for example, location-based services in radiocommunication systems, it would be desirable to make the information provided to client users both more relevant and more organized. In order to provide appropriate prioritization and organization for the users/purchasers, the methods and systems presented below are designed to permit the gathering of data by the users, sellers and/or agents, process the data, store the processed data in cloud architecture, and score or rank the processed data based on multiple factors indicated by the user, seller, agent and/or other collaborators presented in a format to permit the user with a more informed and organized method for making a decision on the good or service to purchase.

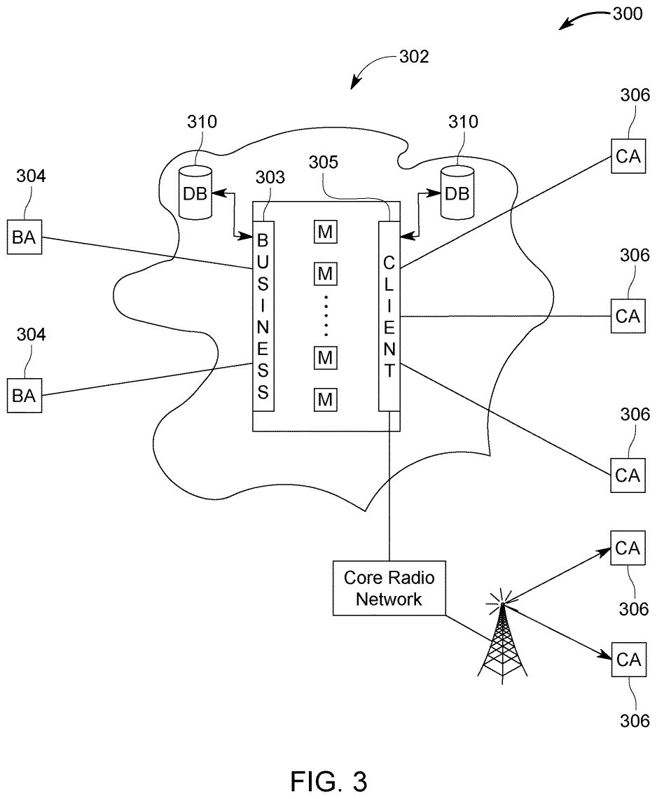

According to an embodiment, one combination of technical features used to realize these types of location-based services is generally illustrated in FIG. 3. More specifically, FIG. 3 illustrates a system 300 according to an embodiment which enables information about products and services to be processed and disseminated to users via their client applications (“apps”).

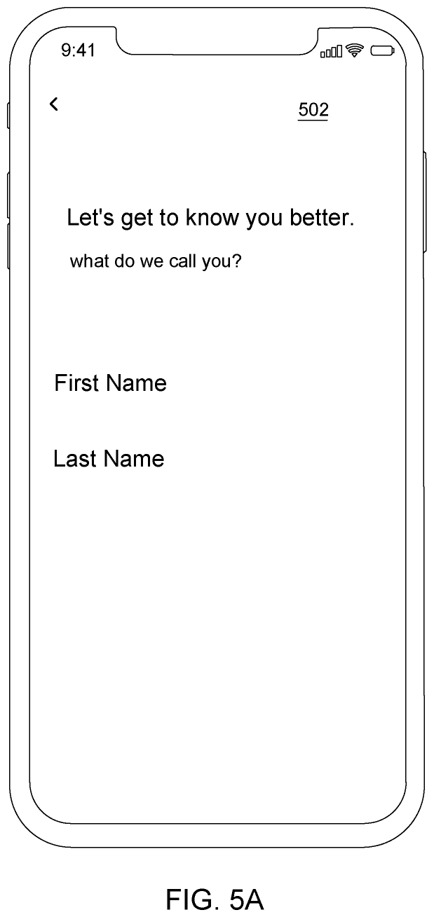

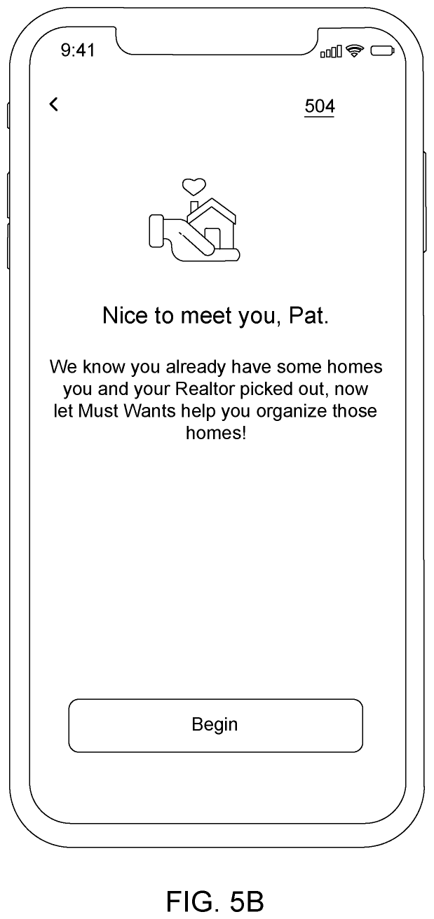

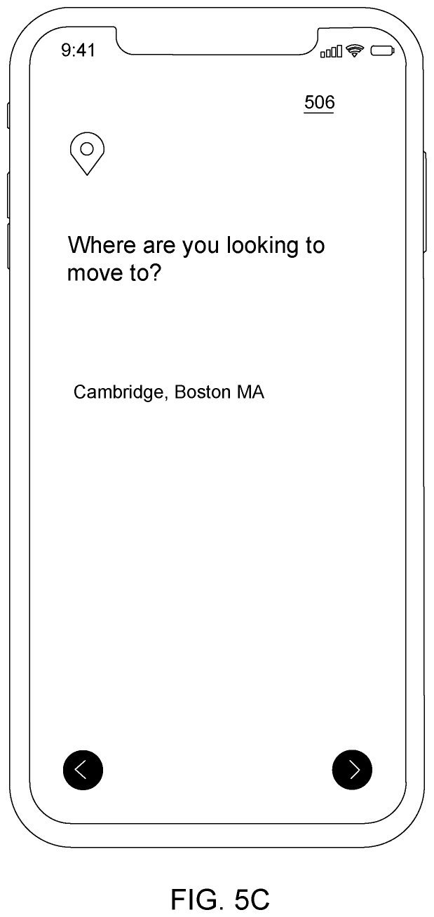

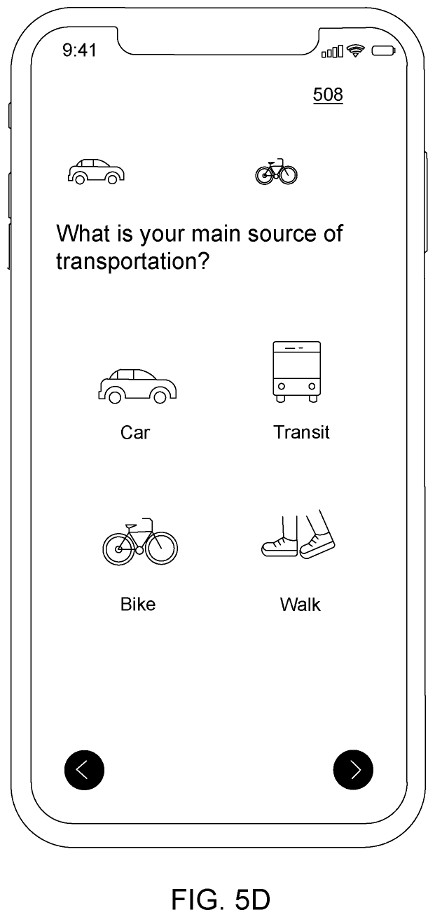

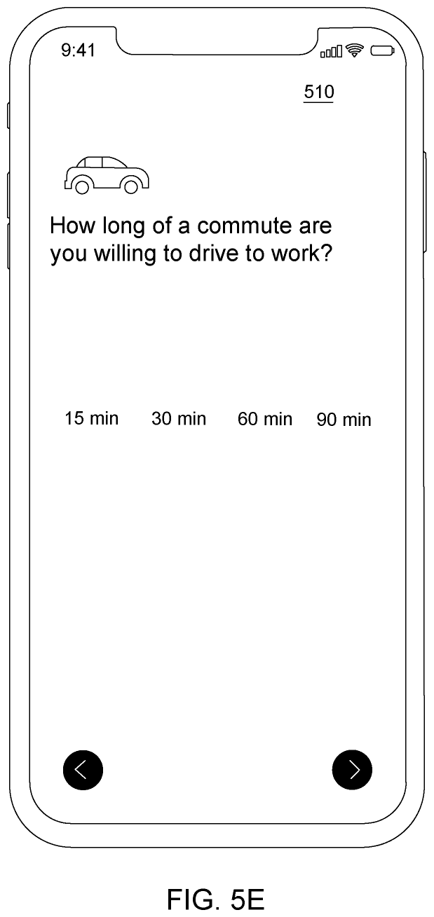

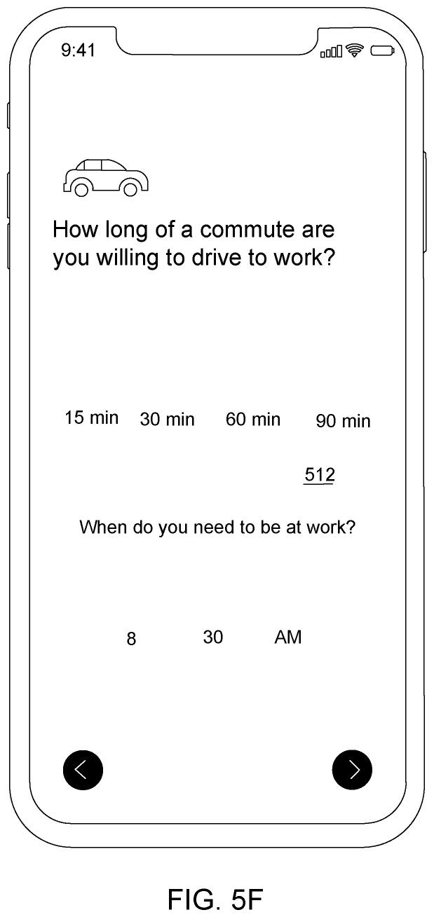

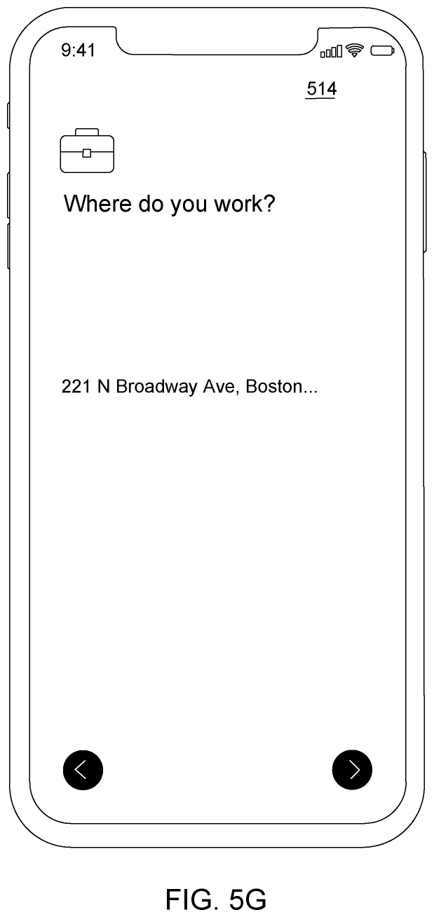

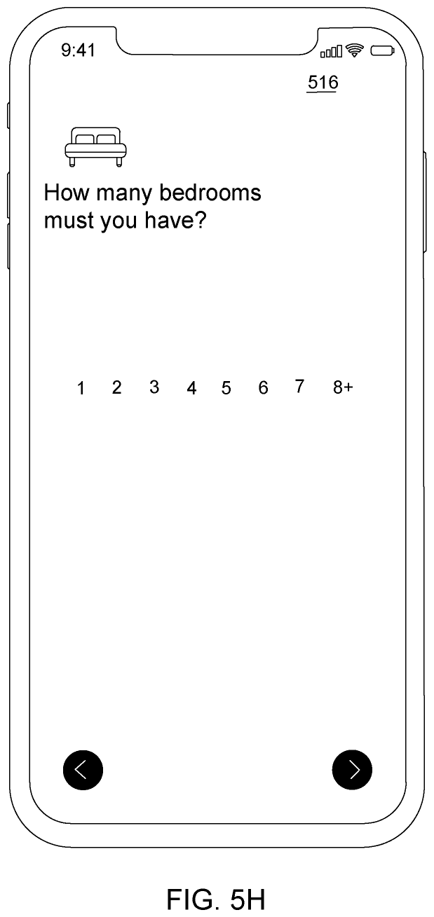

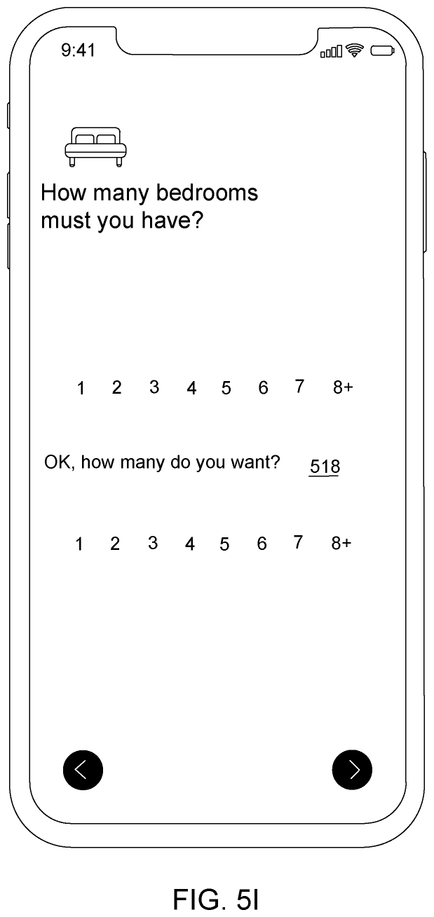

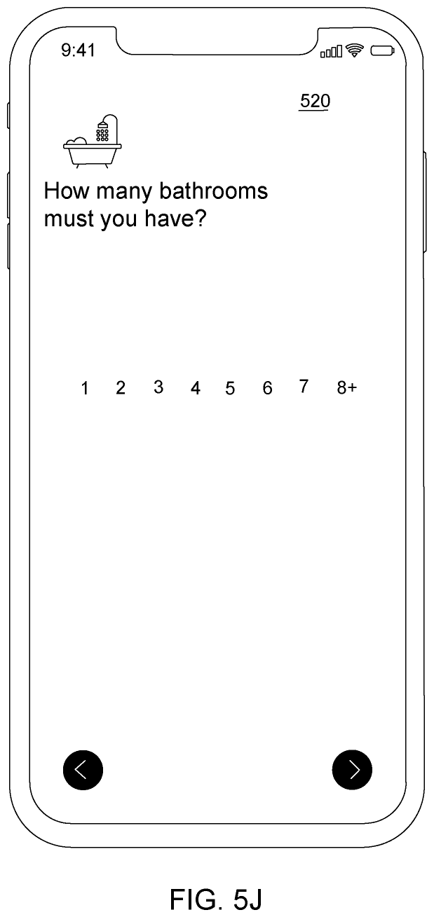

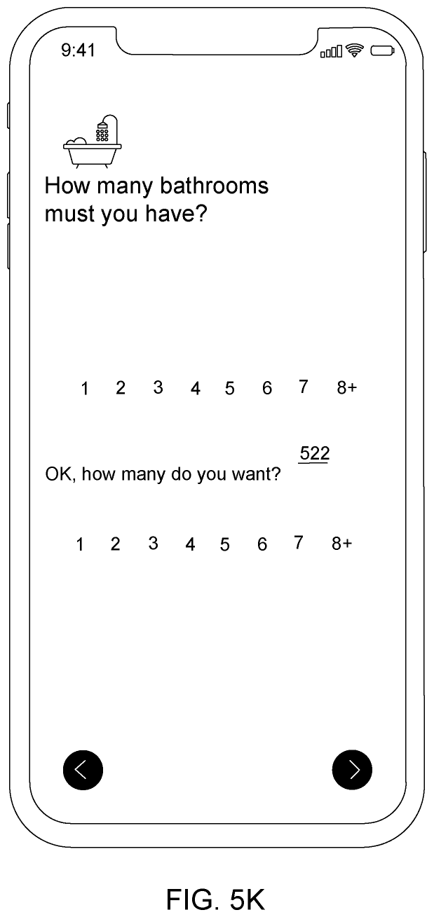

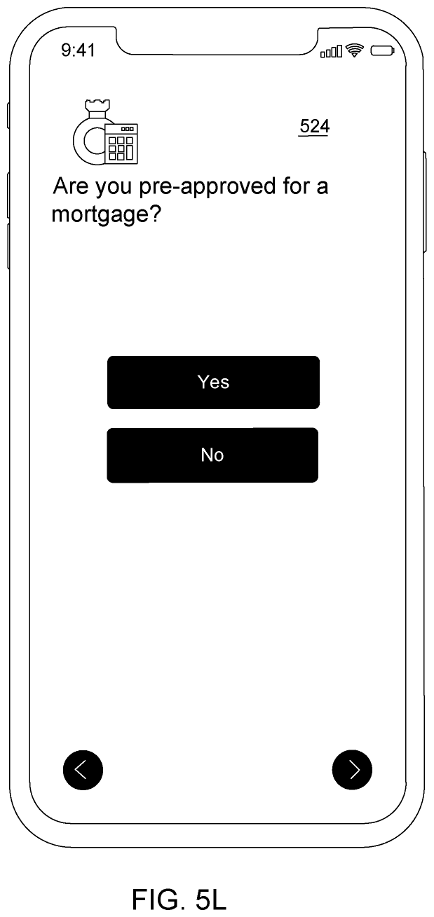

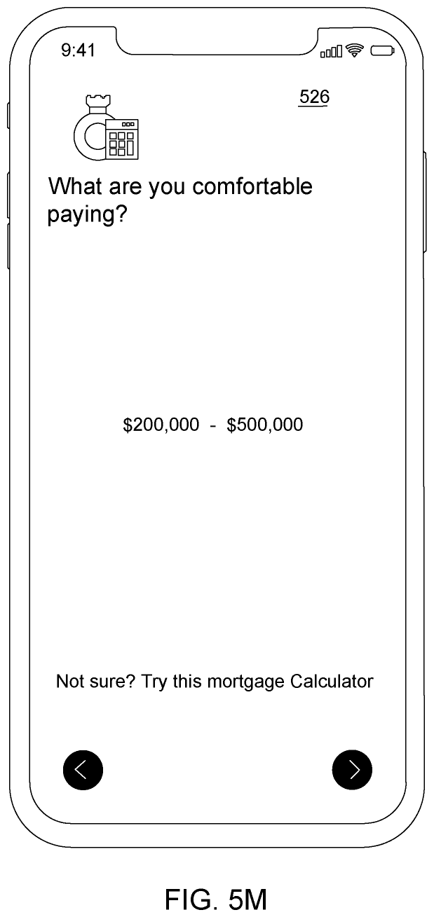

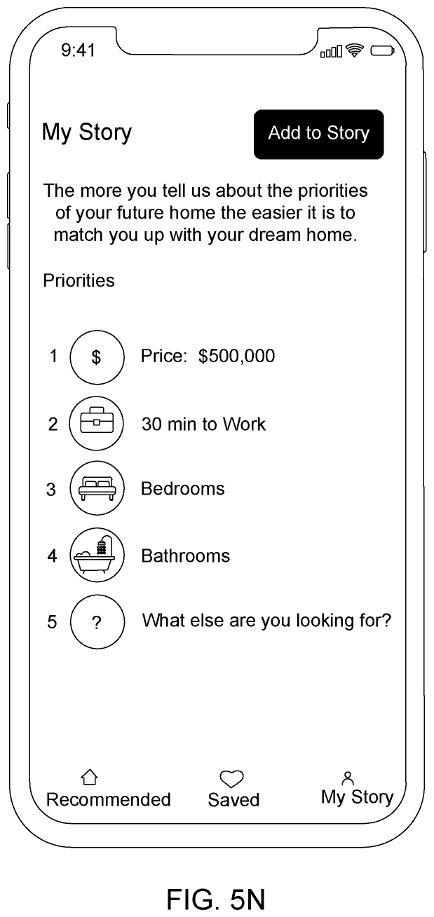

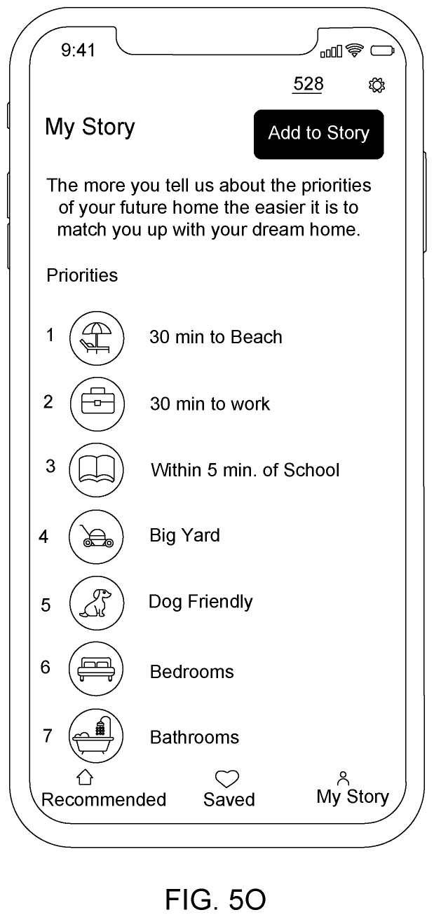

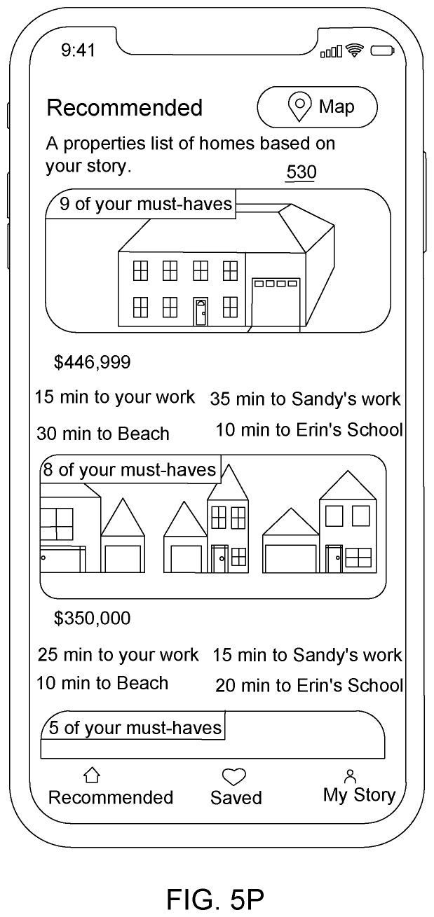

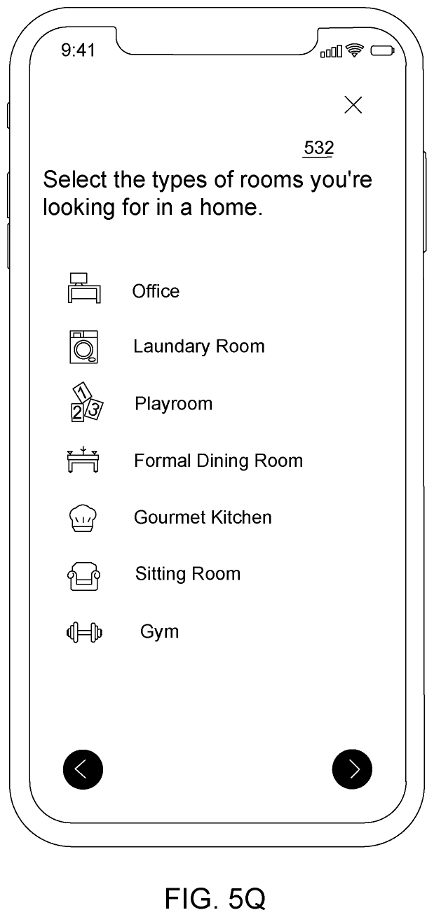

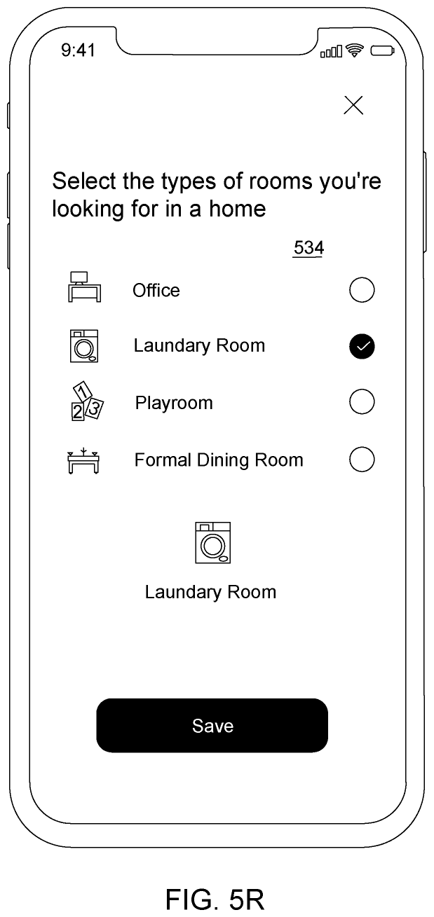

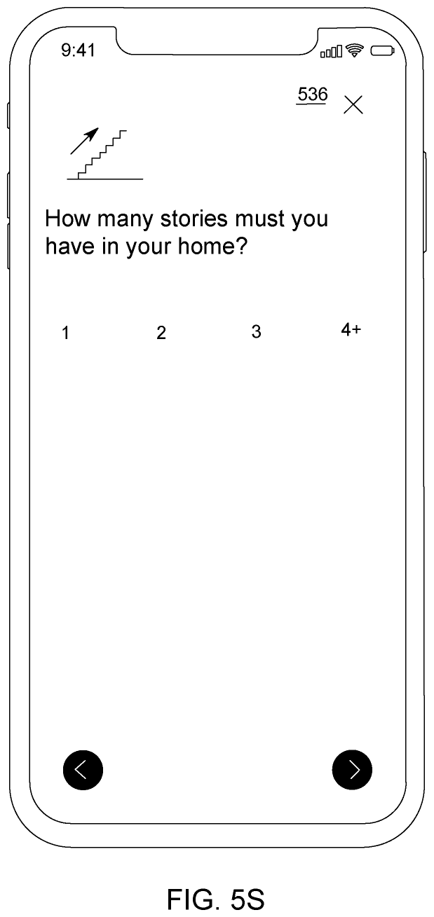

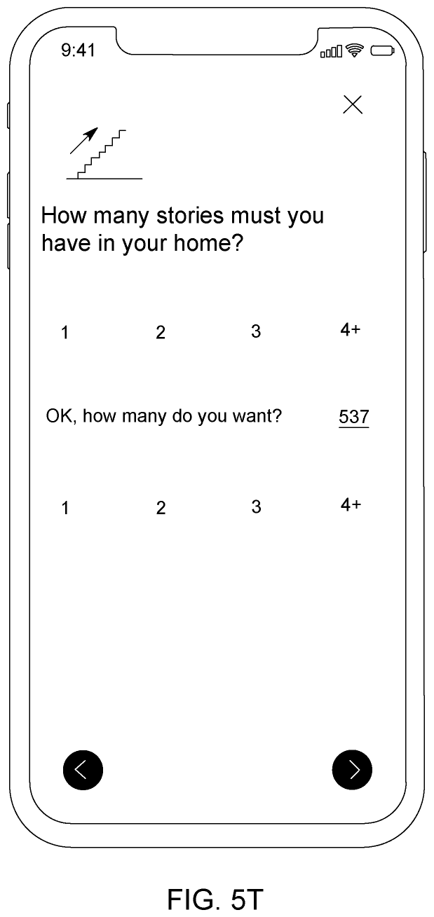

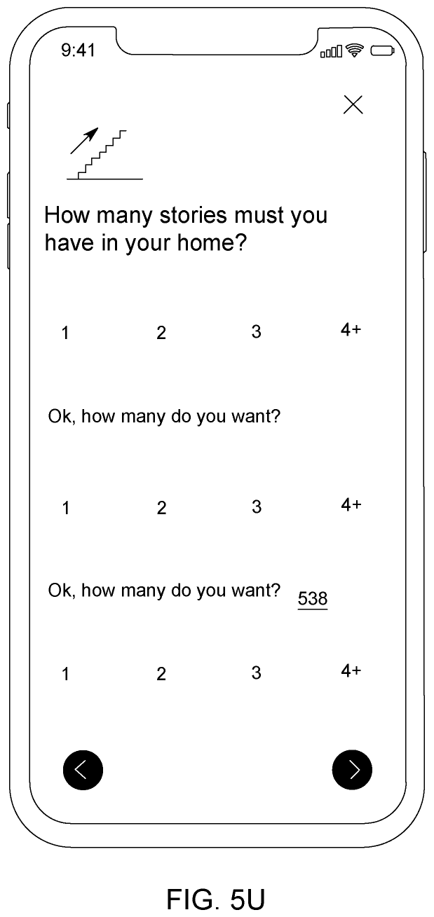

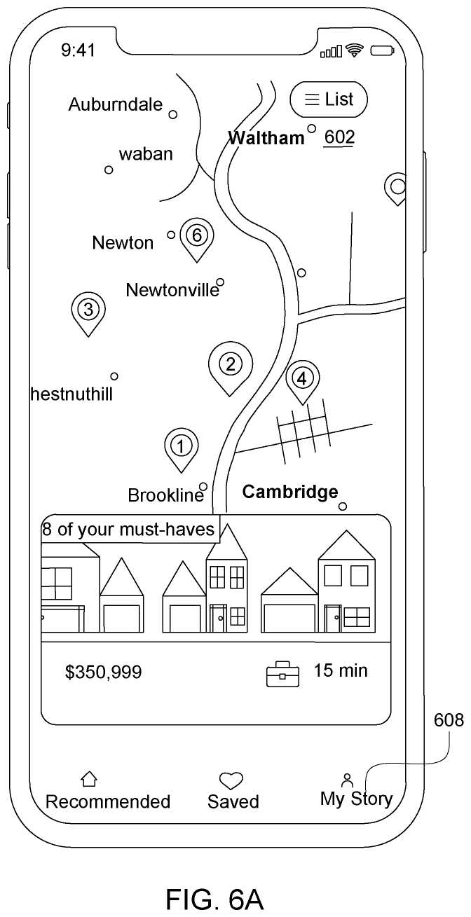

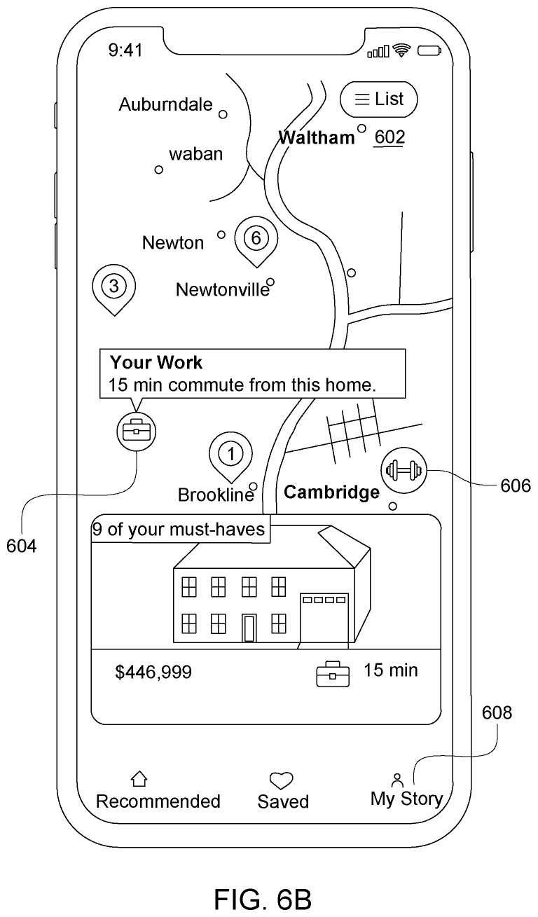

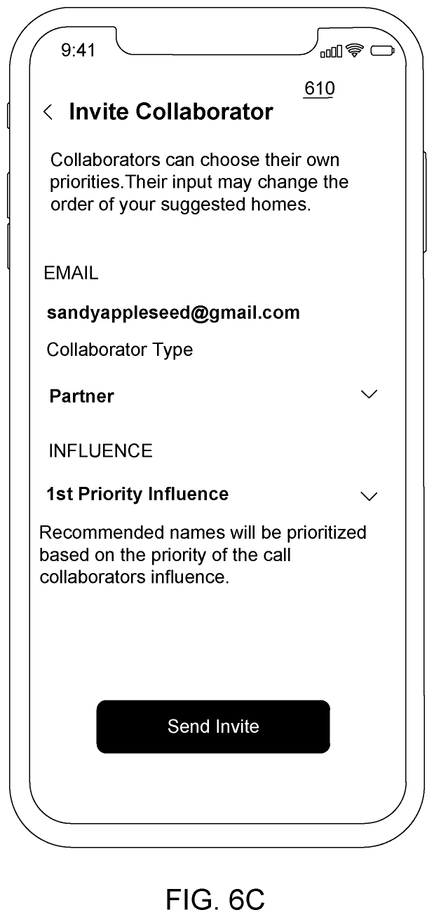

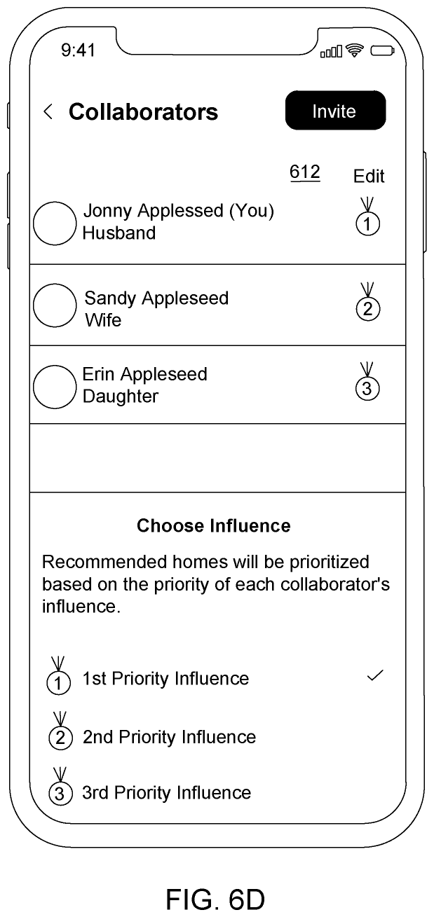

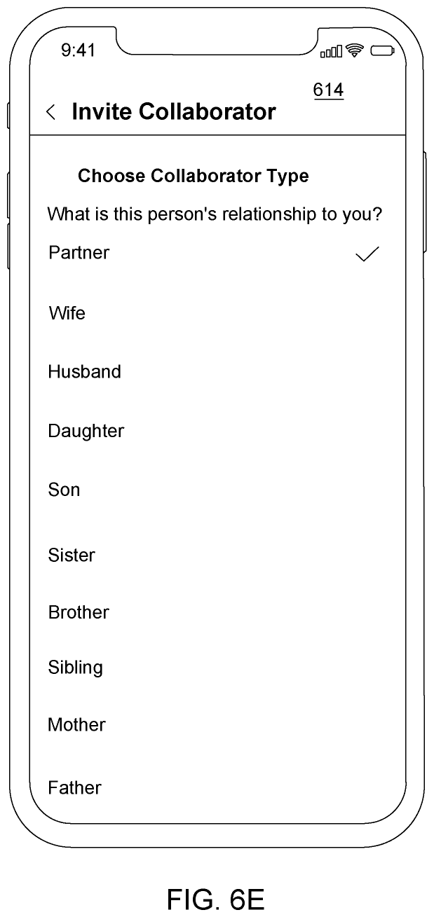

Central to the system 300 is a cloud-based central server 302 which provides an interface 303 toward businesses, represented by computer devices 304 and having a business app (BA) running thereon, as well as a client interface 305 toward users, represented in FIG. 3 by mobile devices 306 having client apps (CA) running thereon. An example of one CA according to an embodiment is described in detail with respect to FIGS. 5A-5U and 6A-6E below. In this context “businesses”, can be any type of organization, e.g., commercial, non-profit, religious, public service or even potentially individuals who either generate and provide information associated with the products and services of interest or who receive information about the users interests with regard to their products and services, or both. According to some embodiments, the BA 304 and CA 306 can be a combined application with both business and client capabilities, while according to other embodiments they can be architected as separate apps. Herein, the reference numeral 306 is used alternatively in this Detailed Description to refer to the user of the system, the user's client/mobile device, the client app or both the client device and the client app as will be appreciated by the context of the relevant portion of the description and, similarly, the reference numeral 304 is used to refer to the business user, the business computing device, the business app or both.

Also shown in FIG. 3 are various modules (M) which support the features and functions associated with the business and client apps and which will be described in more detail below. Note, however, that some of the modules M interact with both the business interface 303 and the client interface 305, e.g., in support of functions where certain data and signaling is provided from a business app 304 to one or more client apps 306 or vice versa, whereas other modules interact with only one of the business interface 303 and client interface 305, e.g., in support of functions which do not involve the transfer of information from the business side to the client side, or vice versa. In certain circumstances, and according to some embodiments, the system 300 is designed to prevent businesses from acquiring information regarding a user 306's location (and other personal information of the users) so as to safeguard users' privacy. As can be seen in FIG. 3, connections between the cloud server 302 and the client devices 306 can involve either wireline and/or wireless connections (and the same holds for the business devices 304 as well).

The functions provided by modules M (which can be implemented as a combination of hardware and software to be described in more detail below) are intended, at a high level, to provide both constraints and incentives towards both the business side and the client side of the system 300. For example, as regards the business side of the system 300, one of the modules M enables the business apps 304 to upload product and/or service information which will be displayed on one or more client apps 306 when certain conditions are met. Examples of such displayed information are provided below. Another module M is responsible to enforce a time limit associated with the uploaded product/service information, essentially operating as an expiration time/date for the uploaded information. In this way, system 300 enhances the likely reliability of the content of the product and/or service information, making it significantly more likely that the product or service represented by the uploaded information is still available for sale at the stated price.

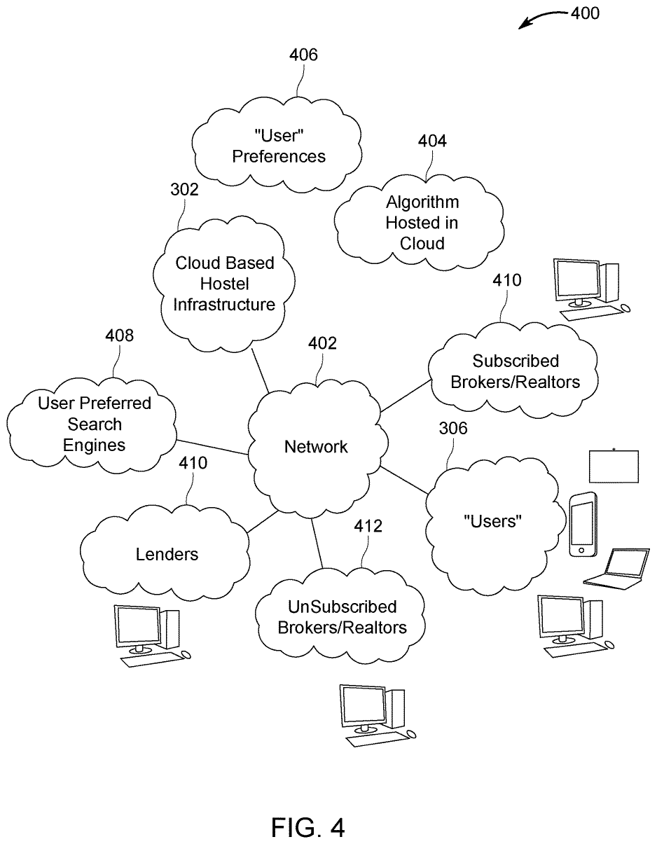

Looking at the client side, the system 300 is also provided with various functionality intended to incentivize end users 306 to use the system 300 to find, e.g., services or products that they are interested in purchasing or using, e.g., within a geographic area of interest. For example, by providing users with filtered, ranked information about local real estate, etc., that they can rely upon to be accurate, the system 300 provides users 306 with a single interface for quickly obtaining all of this information without needing to navigate to numerous websites that may or may not have the information that they are seeking. Indeed, systems and methods designed in accordance with one embodiment can be used to gather, filter, prioritize and list different real estate properties for sale based on user preferences. A high-level architecture of such a system 400 is illustrated in FIG. 4.

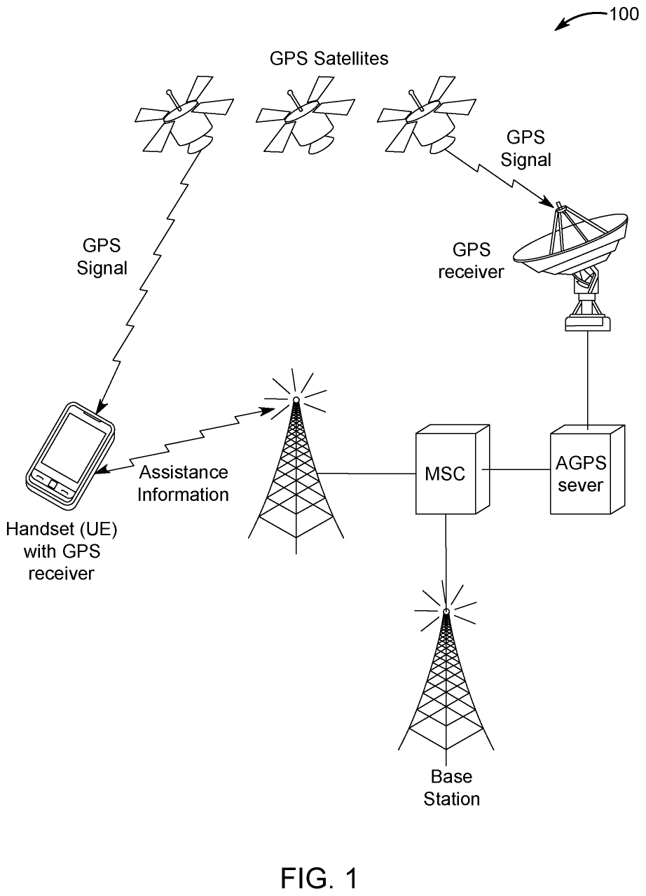

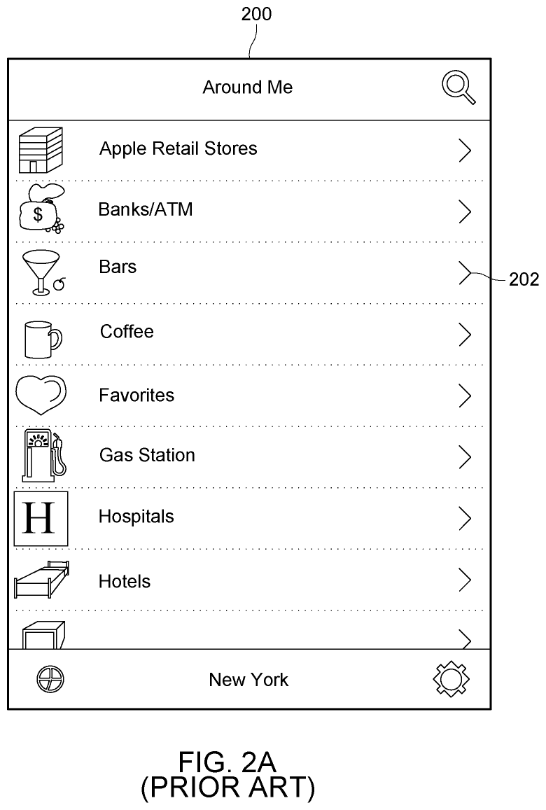

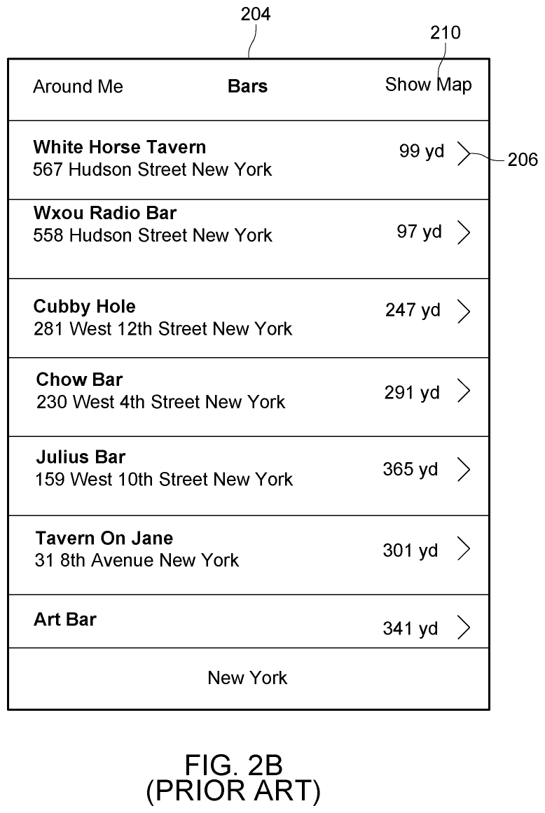

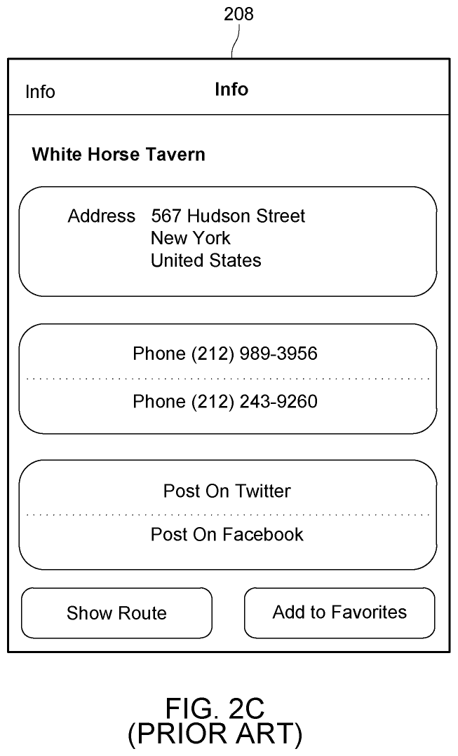

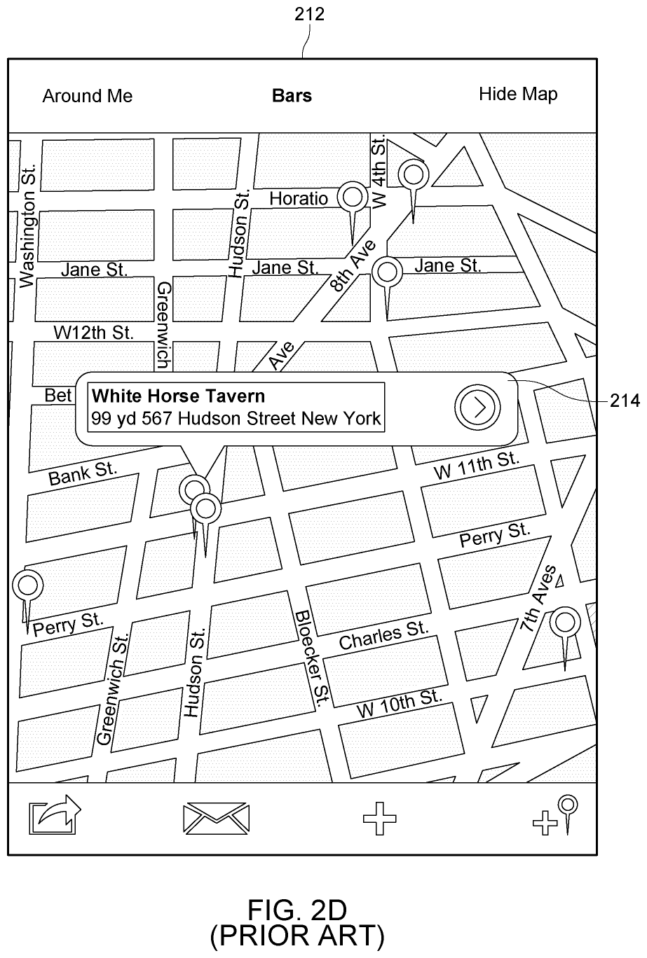

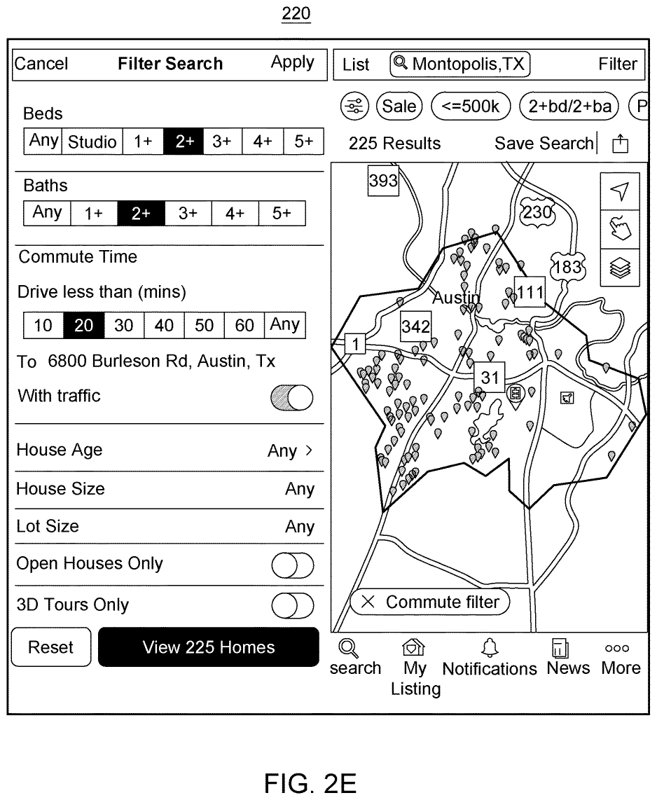

Therein, users 306 communicate with other nodes in the system via network 402 which can, for example, be or include a radiocommunication system 100 such as that illustrated in FIG. 1. This network 100 enables the users and their client app 306 to access the system 400 which includes one or more algorithms 404 for processing data associated with the desired goods or services using the user's preferences 406. Detailed examples of both algorithms 404 and user preferences 406 are provided below. In order to initially gather the data to be processed by the algorithms 404 in view of the user preferences 406, the system 400 can engage one or more user preferred search engines 408 via network 402. Also shown in FIG. 4 are various business entities including subscribed brokers/realtors 410, unsubscribed brokers/realtors 412 and lenders 414 which can selectively be provided with information associated with users preferred real estate properties as they use their client apps 306 to gather and prioritize information associated therewith.

It will be appreciated that although real estate properties or services are used as one example of goods or services that can be gathered and prioritized using systems and methods operating in accordance with embodiments described herein that the present invention is not limited thereto. Virtually any type of good or service is amenable to being processed in accordance with systems according to these embodiments including, for example, choices or preferences in dining, choices or preferences in vehicles, choices or preferences in couches, choices or preferences in vacations, choices or preferences in cleaning, or repair services, choices or preferences in bands or entertainment.

Returning to a more generalized discussion of the embodiments, there are several features incorporated therein which enhance systems and methods for prioritizing, organizing and selecting goods and services. These systems and methods enable the flexible preferences of the user, e.g., preferences 406 associated with the goods and services which can be categorized based on their relative strength as “musts”, “wants”, “haves”, “do not wants”, etc., and other options the user defines as personal emotional indicators. Additionally, these methods and systems can include optional collaborator weights in terms of those preferences, if permitted by the user of the client app 306. Detailed examples of how a user's preferences 406 (and collaborator preferences) are input (as part of an onboarding process) and used are provided below.

Generally speaking, however, in accordance with various embodiments, in order to process the preferences indicated by the user, the user selects the good or service sought, and the user determines the method for searching for that good or service, e.g., using one or more user-preferred search engines 408. Once the search engine(s) or search methodology is identified, the system can process the data identified by the search engine(s) 408 using the algorithm(s) 404 and user preferences 406 for that good or service to organize and prioritize the rawer data provided by the search engine(s) 408 to generate, e.g., a ranked list of individual goods that are available. The user 306 can save, e.g., favorites of that selected good or service in memory in the cloud and/or on his or her local client device 306.

According to various embodiments, an individual user's preferences for a particular good or service can be obtained by the system 400 by way of an onboarding process during which the user indicates his or her preferences via a question-and-answer session. An example will now be provided in the context of real estate services. Initially, as shown in FIG. 5A, the client app 306 can display a screen 502 asking for the user's name. One of ordinary skill in the art will appreciate that references to a screen herein are intended broadly to include separate screen displays as well as incremental or modified displays rendered on an existing screen. Such screens can be interfaces and can output information to the user and can also receive user input, including selections, entries, or other interactions. When the user has input his or her name (or other identifier), the client app 306 can then display a let's get started message screen 504, an example of which is seen in FIG. 5B. Some higher-level questions about the real estate that this user is interested in can then be presented as part of the onboarding process. For example, as shown in FIG. 5C, the client app 306 can display a user interface screen 506 which prompts the user to input the area in which he or she is looking to purchase real estate.

Typically, commuting is an important concern for people purchasing real estate or seeking a vacation or location for a business. According to embodiments, the onboarding process can thus acquire preference data about the user's commuting desires. For example, in FIGS. 5D and 5E, the client app 306 can ask about the user's main form of transportation and how long she or he is willing to commute to work each day by displaying transportation and commute screens 508, 510. This topic can be further refined by also onboarding the user's time at which she or he needs to be at work as shown in FIG. 5F and where his or her workplace is located in FIG. 5G by displaying job start and job location screens 512, 514. The client app 306 could, of course, ask additional questions regarding commuting depending upon how the algorithm(s) 404 are designed. In addition, commuting time or distance to schools, restaurants, stores, churches, parks could also be included to refine the priority and preferences.

Another category of preferences related to the purchase of real estate revolves around aspects of the desired property itself. For example, if the property of interest to the user is a residential home, then he or she might have a desired number of bedrooms that the property should have. Note that, in this context, embodiments can be tailored to further onboard user preference data in a more nuanced fashion, for example by distinguishing between so-called “must haves” and “want to haves”. Thus, as seen in FIGS. 5H and 5I, respectively, the client app 306 can ask the user to input both the number of bedrooms that the user's to be purchased property “must have” and how many bedrooms the user would “want to have” by displaying bedroom must and want screens 516, 518. Similarly, as seen in FIGS. 5J and 5K, respectively, the onboarding process can ask the same questions about the number of bathrooms by displaying bathroom must and want screens 520, 522. Such questions regarding preferences about the attributes of the desired process can, of course, continue, however in the interest of brevity the discussion now turns to other aspects of home buying.

Thus, as shown in FIG. 5L, the client app 306 can ask the user if he or she is pre-approved for a mortgage by displaying mortgage screen 524 or, alternatively (or additionally) the client app 306 can ask the user the purchase price range for the property that she or he is comfortable with as shown by the price range screen 526 of FIG. 5M. The onboarding process can continue by starting to use the information already gathered to refine the user's preferences. For example, as shown in the priorities screen 528 FIG. 5N, the client app 306 can ask the user to prioritize the user's previously input purchase price, distance to work, number of bedrooms, number of bathrooms, etc., and can add additional priorities which were not previously specified. FIG. 5O shows another version of the priorities screen 528 of FIG. 5N with a different list of prioritized preferences.

It will be appreciated by those skilled in the art that the examples of different types of preferences that could be presented to a user 306 as part of an onboarding process according to the various embodiments described above are not exhaustive and that many other preferences could be specified and then prioritized. Using the specified and prioritized preferences 406, the system 400 using algorithm(s) 404 and data acquired from the selected search engine(s) 408 can then generate and display a list of recommendations of the desired product or service, e.g., real estate properties, an example of which is illustrated in the client app 306 recommendations screen 530 shown in FIG. 5P. Therein it can be seen that the list indicates a number of things about each property, for example the number of must haves that the property satisfies, as well as specifications of what each property provides relative to the user's prioritized preferences. For example, the recommended list could display the metrics associated with the top four preferences in the user's preference list, e.g., how long will it take to reach my workplace, how long will it take to reach my wife's workplace, how far away is the beach and how far away is our daughter's school. Using these embodiments, no longer does a user have to guesstimate these important values his or herself, instead the system 400 delivers them and presents them on the user's client device 306. More information regarding the prioritized list of recommended products or services is provided below.

The onboarding process according to some embodiments can involve a more detailed series of additional questions regarding what a user is looking for in the context of the relevant goods and services. For example, continuing with the real estate embodiment, the user can be prompted to indicate other types of rooms that she or he is looking for in a property using an other rooms screen 532 such as that shown in FIG. 5Q. Like other preferences which are set during the onboarding process, room type can also be assigned its own internal priority as shown, for example, in an other rooms priority screen 534 of FIG. 5R. Alternatively, the onboarding process could ask the user for his or her preferences and preference priority in different ways see, e.g., by displaying a stories must screen 536 of FIG. 5S. Preference priorities for a given preference can have several dimensions, e.g., the system 400 could ask a user both how many stories a property must have for him or her to be interested (as shown in FIG. 5S), but also ask that user how many stories he or she would want the property to have by displaying the stories want screen 537, an example of which is shown in FIG. 5T. Indeed, according to some embodiments, preference types (e.g., number of stories) can have many different type values, e.g., as shown by the stories not want screen 538 in FIG. 5U.

Before discussing that, however, a more detailed discussion regarding how the system 400 uses the preferences 406 to generate the prioritized list of recommendations is first presented. In order to generate the prioritized or ranked list of recommended products or services, the system 400 first takes the data obtained by the search engines, e.g., property listing data of properties for sale in a certain zipcode or set of zipcodes, and assigns scores to each property for each preference expressed by the user as being important to him or her in their search. For example, if a user selects distance to work of 30 minutes or less as a must have preference, the system 400 could use the raw list provided by the search engines 408 of properties within the desired zipcode or set of zipcodes and assign a score to the “work commute time” preference based on the distance of each property from the user's work place. The scoring for this parameter could be performed in any desired way. For example, the system 400 could assign a score of 1 to a property that is within 6 minutes, a property that is within 12 minutes a score of 1, a property that is within 18 minutes a score of 2, a property that is within 24 minutes a score of 2, a property that is within 30 minutes a score of 3 and any other property that is further than 30 minutes a score of 4. The latter is purely an illustrative example and any desired scoring system can be put into place for each preference attribute.

For example, using a desired algorithm, the system 400 could generate a set of score values for each of the user 306's top preferences for one property as exemplified in Table 1 below using the prioritized preferences shown in FIG. 5O.

TABLE 1

| Priority | Preference | Score |
|---|---|---|
| 1 | 30 Min To Beach | 1 |
| 2 | 30 Min to Work | 1 |
| 3 | Within 5 Miles of School | 1 |
| 4 | Big Yard | 1 |
| 5 | Dog Friendly | 1 |
| 6 | Bedrooms (Must 3) | 2 |
| 6 | Bedrooms (Want 4) | 1 |
| 7 | Bathrooms (Must 2) | 2 |
| 7 | Bathrooms (Want 3) | 1 |

As seen in Table 1, and as discussed previously, some preferences can, in addition to being assigned a general priority level which ranks each preference relative to other preferences, can also have different internal preference indications, e.g., the number of bedrooms that the user 306 must have is 3, but wants to have 4 bedrooms. In the example of Table 1, the property being scored had 3 bedrooms and 3 baths, thus scoring 2 for the desired quality of having 3 bedrooms, but scoring 1 for the desired quality of 3 bathrooms.

Once the system 400 has scored all of the relevant properties for each user preference 406, it can then generate a composite score for each property using one of the algorithms 404 and the previously generated preference scores.

According to one embodiment, the composite score (also referred to herein as the “ranking value” can be calculated using an algorithm 404 as:

$$Ranking value = ( Average of High Importance Scores + Average of Moderate Importance Indicia Scores \times 0.1 + Average of Low Importance Indicia Scores \times 0.01 \times Human Factor \times Neighborhood Influencer ) \qquad ( 1 )$$

where Human Factor is an average of rankings given by area experts and/or property owners for each specific property and Neighborhood Influencer is a multiplier based on demographics. In equation (1) it can be seen that the ranking value is calculated by summing weighted averages of high, moderate and low importance scores (such as those shown in Table 1). Initially, it should be noted that although equation (1) bins the user's preferences into three different levels of importance, different embodiments can use any number of bins. For example, as previously discussed, a user can categorize a preference as being a “must”, a “want”, a “have”, and/or a “do not want”. According to some embodiments, a user 306 can select the number of bins him or herself to personalize the ranking system 400.

Similarly, although the three weighting factors illustrated in equation (1)—i.e., 1, 0.1, and 0.01 for high-importance, moderate-importance, and low-importance indicia—average scores, respectively—those skilled in the art will appreciate that other weighting values can be chosen to appropriately weight different importance levels and generate a ranked list which accurately reflects a user's desired product or service, e.g., a real estate property. Like the number of preference bins, according to some embodiments, the user 306 can select the weighting values him or herself.

Moreover, according to some embodiments the Human Factor and/or Neighborhood Influencer multipliers can be omitted.

As mentioned previously, equation (1) is one example of an algorithm 404 which can be used to generate a ranked list of products or services. Other embodiments can use other algorithms. For example, algorithm 404 can include equation (2) below for calculating the ranking value.

$$Ranking value = ( Average of High Score Values for one Building + Average of Moderate Score Values for one Building * 0.1 + Average of Low Score Values for one Building * 0.01 * Human Factor \qquad ( 2 )$$

where Human Factor is the average of rankings given by area experts for the property on a scale of (0, 0.1, 0.2, 0.3 . . . to 1.0).

Thus, in the embodiment associated with equation (2), a maximum result of 10.11 may be obtained as follows for any property (assuming that scoring values are 1-10 per preference rather than 1-100 as shown in the example of Table 1):

$$Max R esult = Round ( 10 + 10 * 0.1 + 10 * 0.01 , 2 ) * 1 = 10.11 \qquad ( 3 )$$

The resulting ranking values for each relevant property in a user 306's search can be stored in a database and, upon request, displayed on the user's client device. Returning to FIG. 5P, an example of such a display is embodied in the recommendations screen 530. Therein, it can be seen that a picture of each property is displayed in order of lowest-scoring as the highest ranking value. Additionally, other information associated with the user's preferences can also be displayed to inform the user about the property's qualifications relative to the user's preferences. For example, the system 400 can superimpose the number of “must have” preferences over a corner of the picture of each property. Additionally, the system can inform the user about the actual metrics of the property relative to the user's preferences, e.g., distance to work, distance to beach, distance to daughter's school, etc. As also seen in FIG. 5P, the properties can be displayed as a ranked list. However, using the map button in the upper left hand corner of the user interface screen of FIG. 5P, the display can switch to a map view where the properties are located on the map using pin icons or the like as shown in the map screen 602 of FIG. 6A. The pins can be numbered to indicate their position in the user's ranked list. When a user selects a pinned property on his or her client device 306, the display can then overlay information about the selected property on the bottom of the display as also seen in FIG. 6A. Alternatively, the overlaid property information can be swiped in either direction such that whichever property information is currently overlaid on the map, the corresponding pin in the map can become highlighted or change color. The geospatial presentation, combined with the system's scoring, assists buyers in recognizing how location factors into cost-value calculations. This presentation also enhances the clarity of communication among users, collaborators and sellers, and sales personnel.

The system 400 can also display icons on the map indicating the locations of places of interest relative to the user 306's preferences. For example, in FIGS. 6A-B the system provides icons showing the locations of the user's place of work (represented by a briefcase icon 604), the user's gym (represented by a barbell icon 606) and the user's daughter's school (represented by a graduation cap icon). Scrolling over or selecting one of these preference icons can, for example, reveal a distance between that preference location and a currently selected property as shown in FIG. 6B.

According to some embodiments, using the above-described geo-location techniques to locate the user's client device 306, the system 400 can also put an icon on the display indicating the user's current location relative to the properties in his or her list. Moreover, the system 400 can also provide directions to each selected property in the list relative to the user's current location so that the user can drive by the property and inspect it visually. If a user finds, for example, a neighborhood that she or he really likes, that user can add a preference (e.g., by clicking on the “My Story” icon 608 at the bottom of the screen) which indicates that the list can be re-ranked to emphasize, e.g., properties within 5 miles of my current location.

The above-described embodiments show how system 400 can provide a user 306 with a ranked list of goods or services which are prioritized based on the user's own personal preferences. However according to other embodiments, the ranked list can be generated also taking into account the inputs/preferences of others, who are referred to herein as “collaborators”. This embodiment highlights the communications component of the collaboration which results in more effective communications related to location and parameters determined through the algorithms.

For example, FIG. 6C depicts an invite collaborator screen 610 screen that can be generated on a user's client device 306 to enable the user to invite a collaborator via, e.g., email. A collaborator can have a type and an influence priority which can, for example, impact the amount of weight that is factored into the generation of the ranked list relative to the user's preferences and other collaborators. As indicated in FIG. 6C, the addition of one or more collaborators can affect the rankings of the goods or services in the list, but this can be useful when the user wants to collaborate on a purchase, e.g., buying a home with a partner or renting a home, or selecting a place to eat, or a type of vehicle to purchase. As shown in the collaborators screen 612 and collaborator type screen 614 of FIGS. 6D and 6E, the influence priority can take one of a plurality of different values, as can the collaborator type, respectively. The collaborator type permits a weighting of the type of collaborator, (i.e 1^{st} Priority Influence is equal to the primary collaborator, 2^{nd} Priority Influence is a 2 weight, and 3^{rd} is a 3 weight which influences the weight of the collaborators preferences within the algorithm).

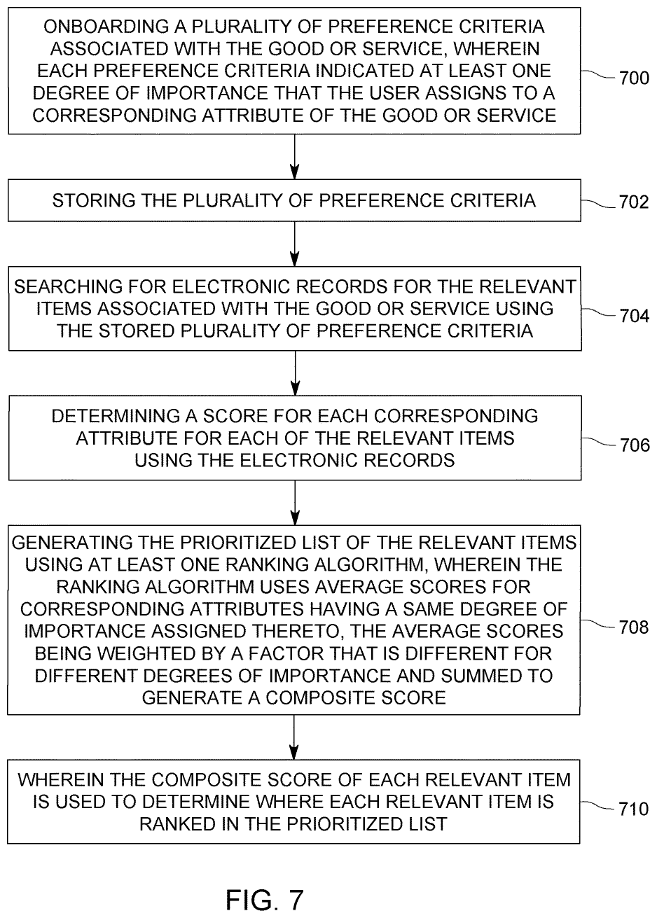

Turning now to method embodiments, FIG. 7 illustrates an example process corresponding to the functionality already described. According to an embodiment, a method for generating a prioritized list of relevant items associated with a good or a service is illustrated in the flowchart of FIG. 7. The method includes, at step 700, onboarding a plurality of preference criteria associated with the good or service, wherein each preference criterion indicates at least one degree of importance that the user assigns to a corresponding attribute of the good or service. Next, at step 702, the method includes storing the plurality of preference criteria by a server and then, at step 704, searching electronic records for relevant items associated with the good or service using the stored plurality of preference criteria. Using this information, the method then determines, for each relevant item, a score for each corresponding attribute using the electronic records at step 706 and generates the prioritized list of the relevant items using at least one ranking algorithm at step 708, wherein the ranking algorithm uses average scores for corresponding attributes having a same degree of importance assigned thereto, the average scores being weighted by a factor that is different for different degrees of importance and summed to generate a composite score at step 708. The composite score of each relevant item may be used to determine where each relevant item is ranked in the prioritized list at step 710.

In operation, the foregoing methods and systems can be used to present a prioritized listing of goods or services to prospective buyers. The process includes algorithms which leverage artificial intelligence methodology and machine learning processing to identify and enhance a user's awareness of the unique attributes of goods or services of interest. Each good or service is represented by unique attributes. The user provides physical or emotional preferences relative to those unique attributes that are cataloged and stored. The process prioritizes the goods or services also by unique attributes provided by the sellers of the goods or services to enable the system to set specific values for the respective fields of importance indicated by the user. Each field is weighted based on the user's preferences as indicated during the onboarding process. Each field is specifically assigned by the user and is discoverable through online-available data: traditionally seller-provided data, manufacturer provided data, third-party-provided data (i.e. feedback, reviews etc.), or user provided data. Additional data from user(s) provide enhanced prioritization, including adding additional users (collaborators) to the specific user profile to cause the resulting prioritization of goods or services to change due to a collaborative score. Additional changes are available through a seller's interface to adjust the priority, if selected. Also, additional changes can be indicated if permitted through alternate third-party input, through permissions provided by the user or seller, depending on the good or service being presented.

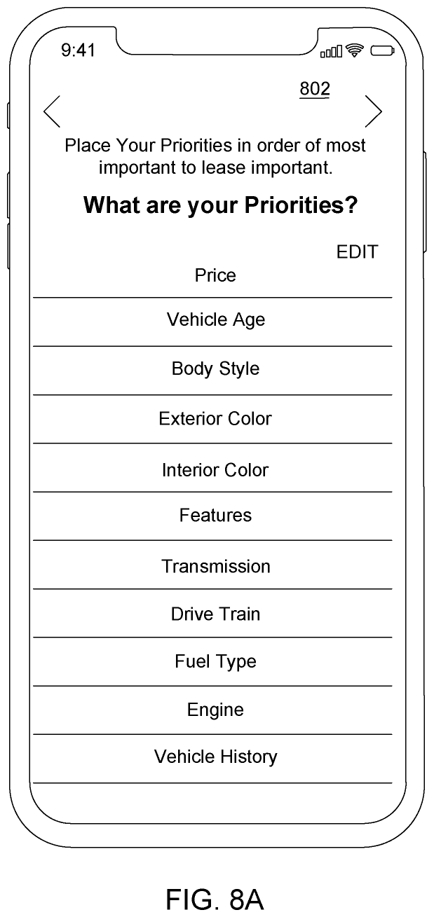

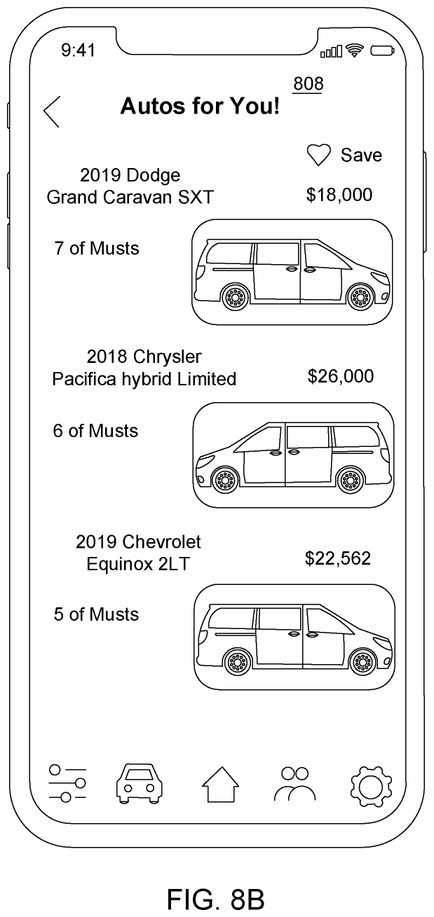

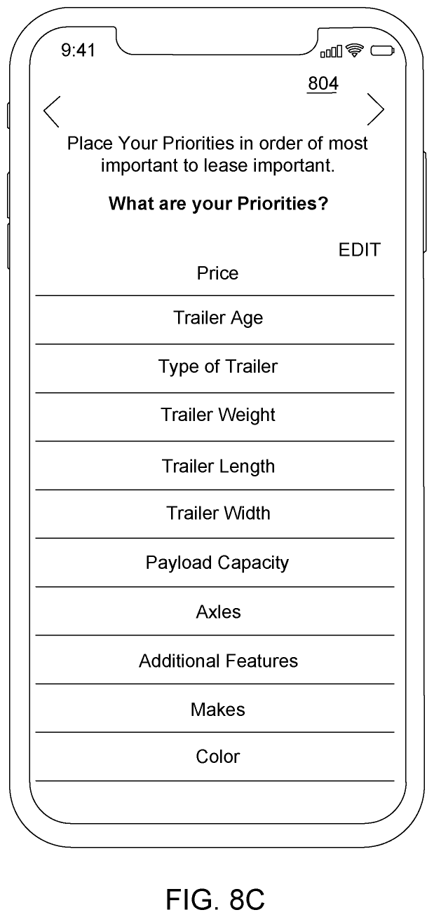

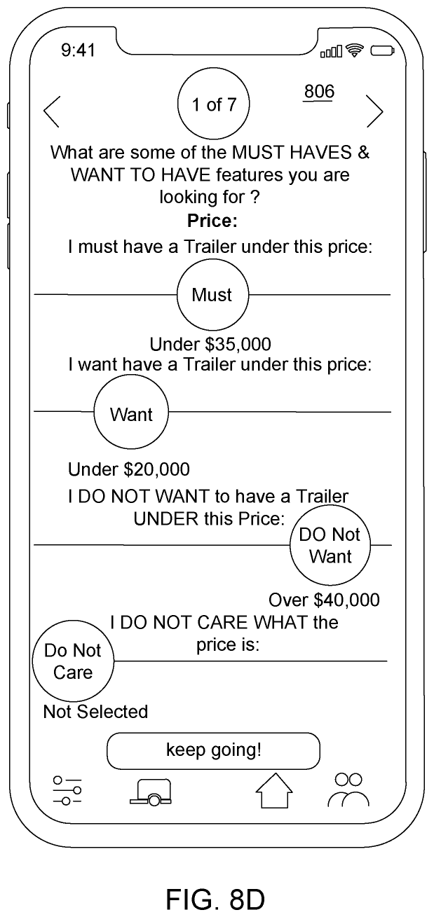

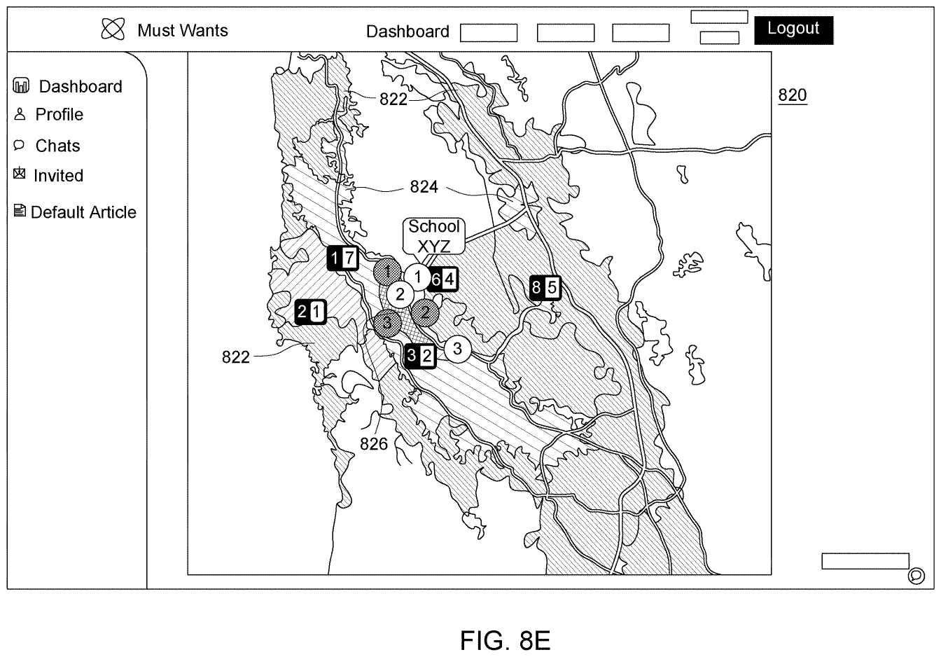

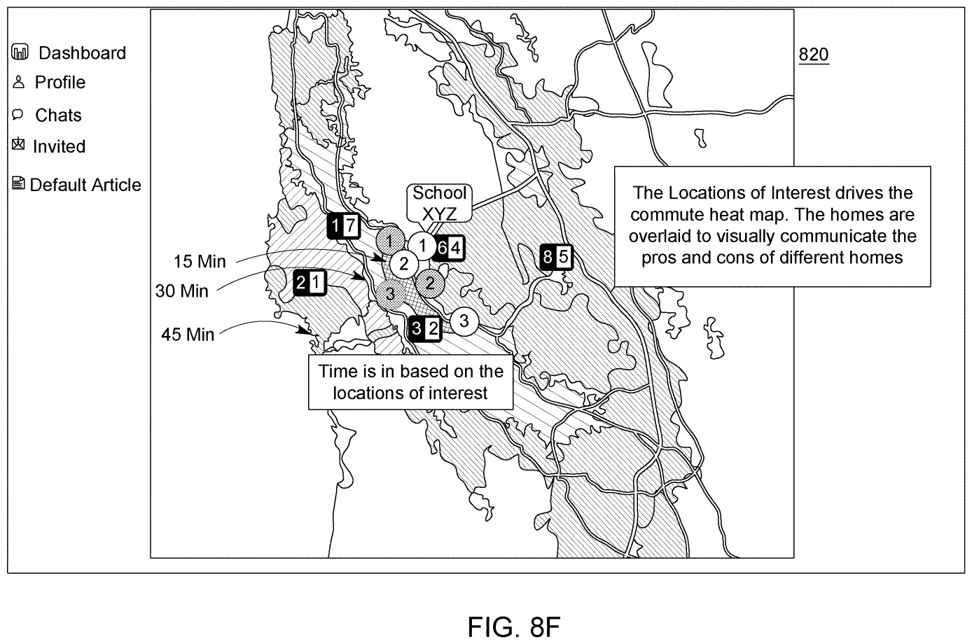

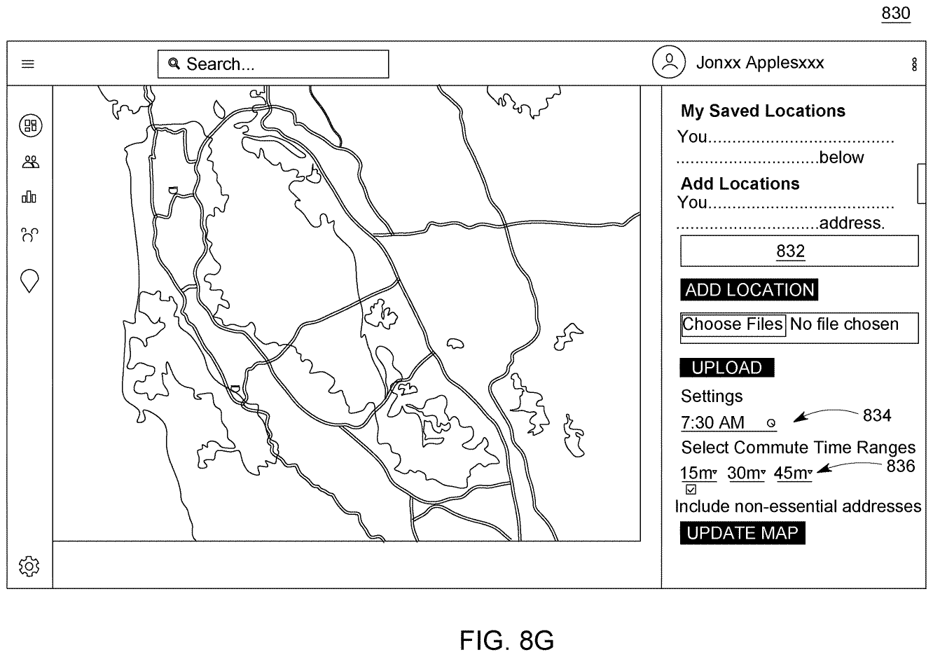

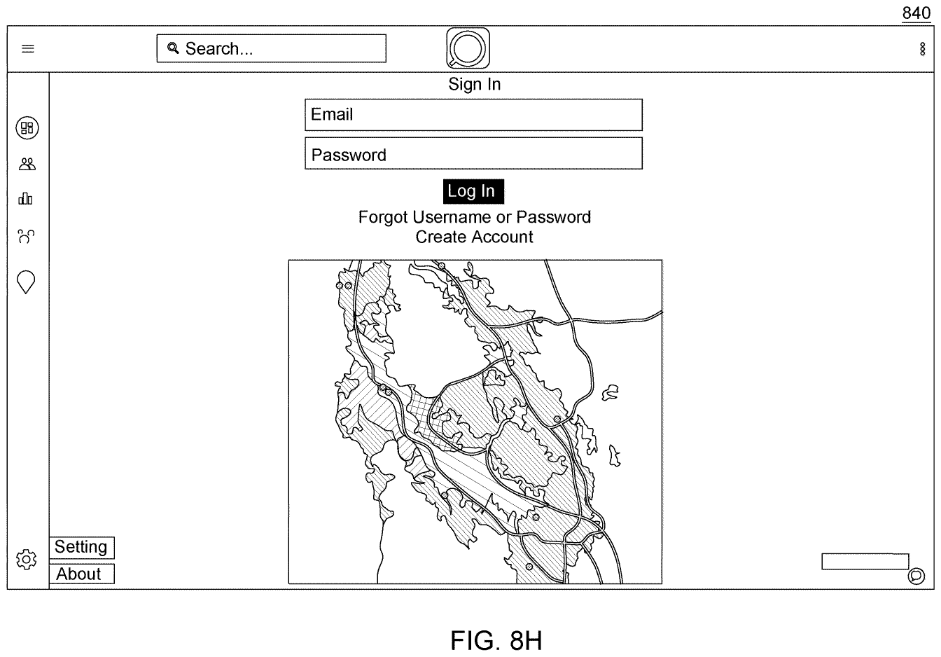

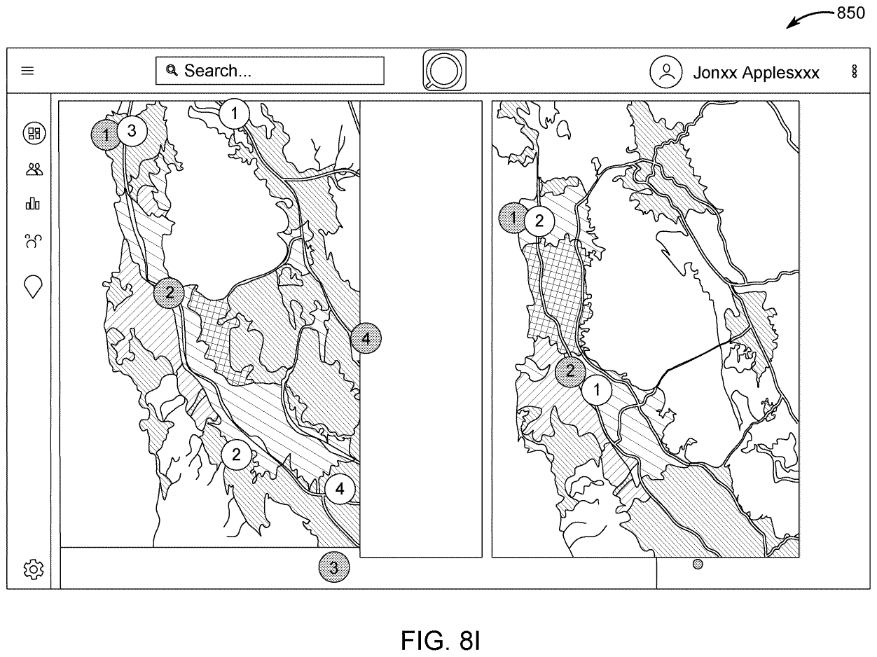

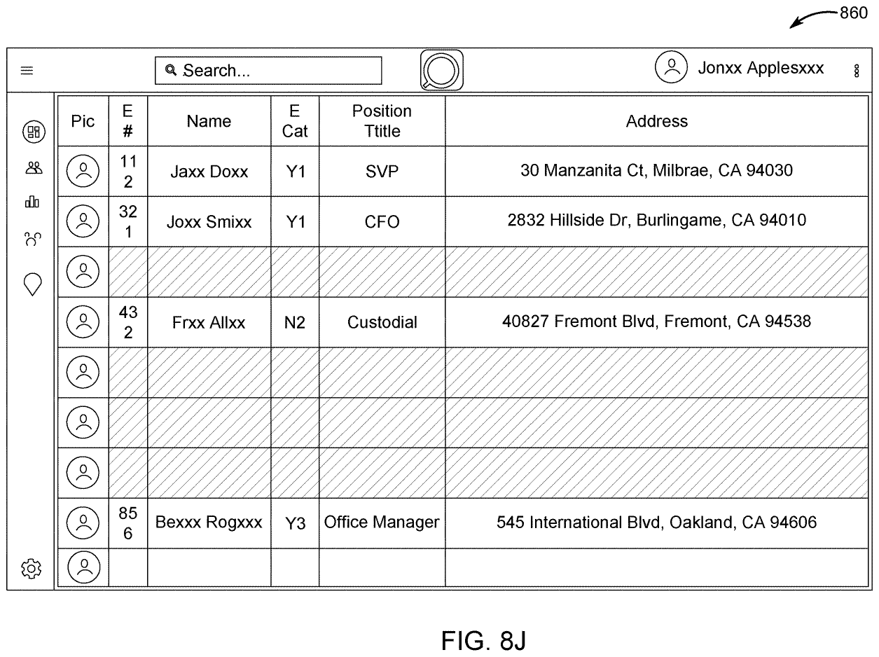

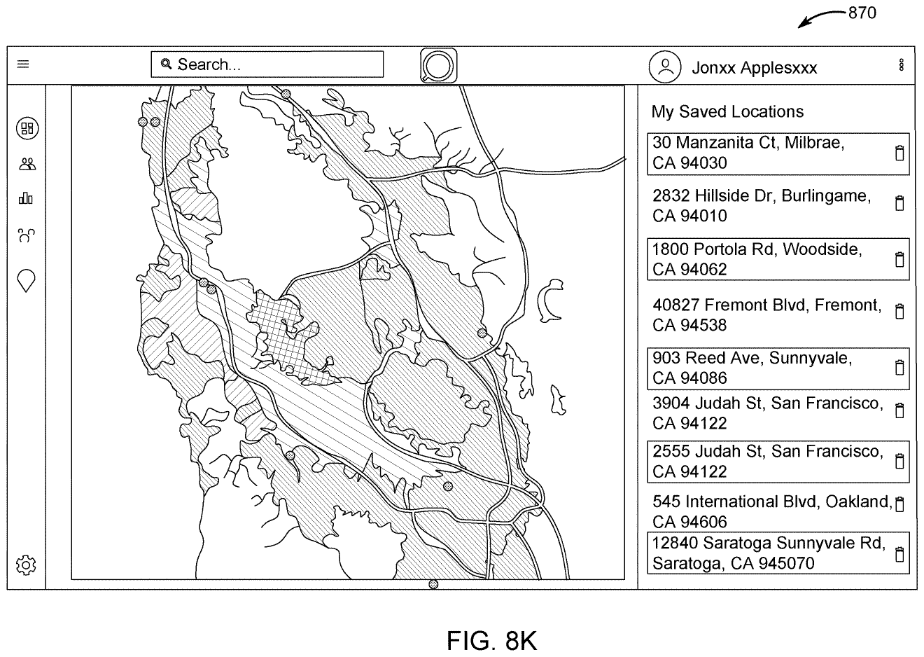

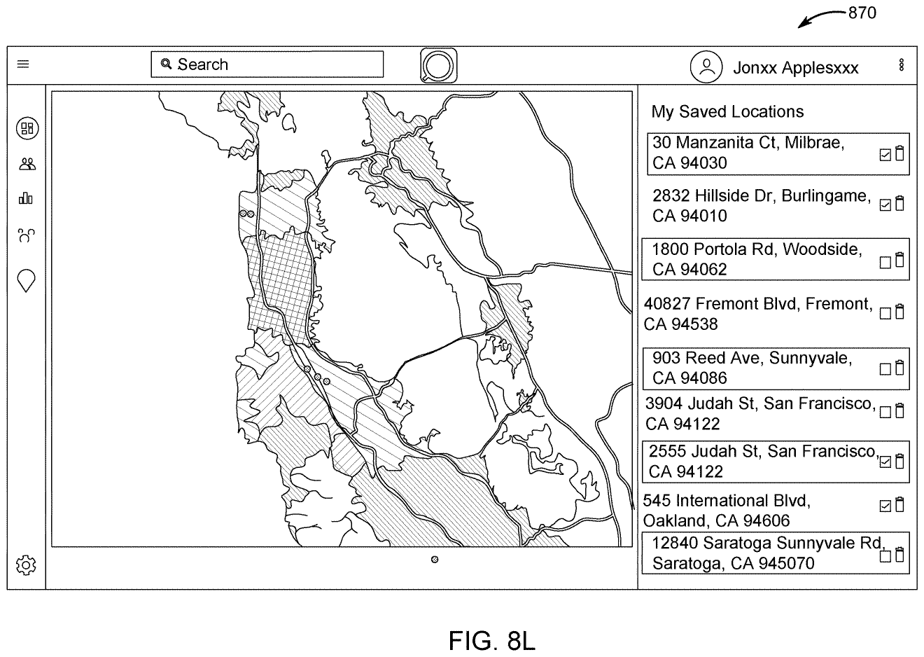

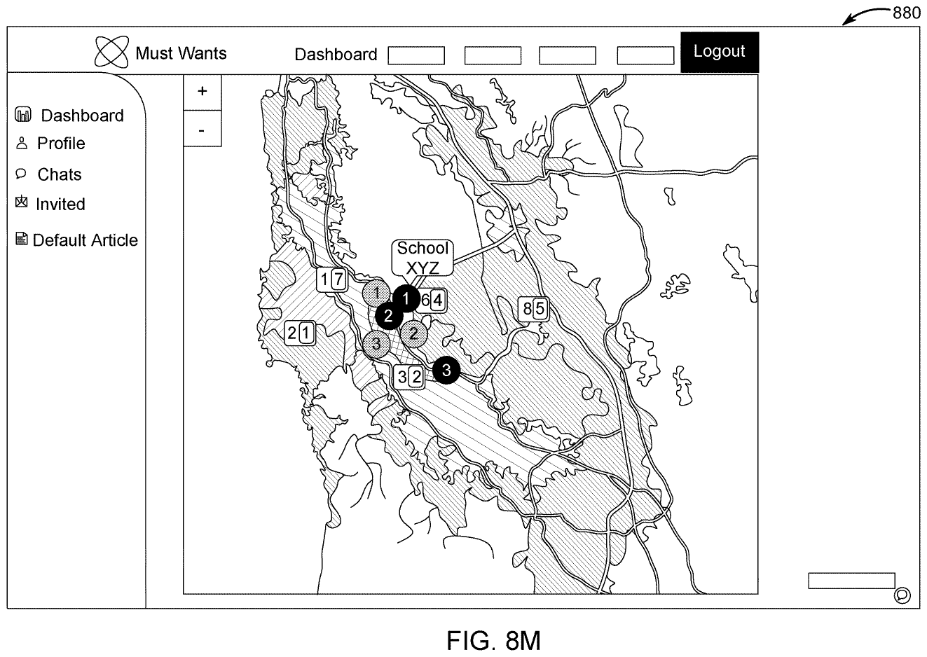

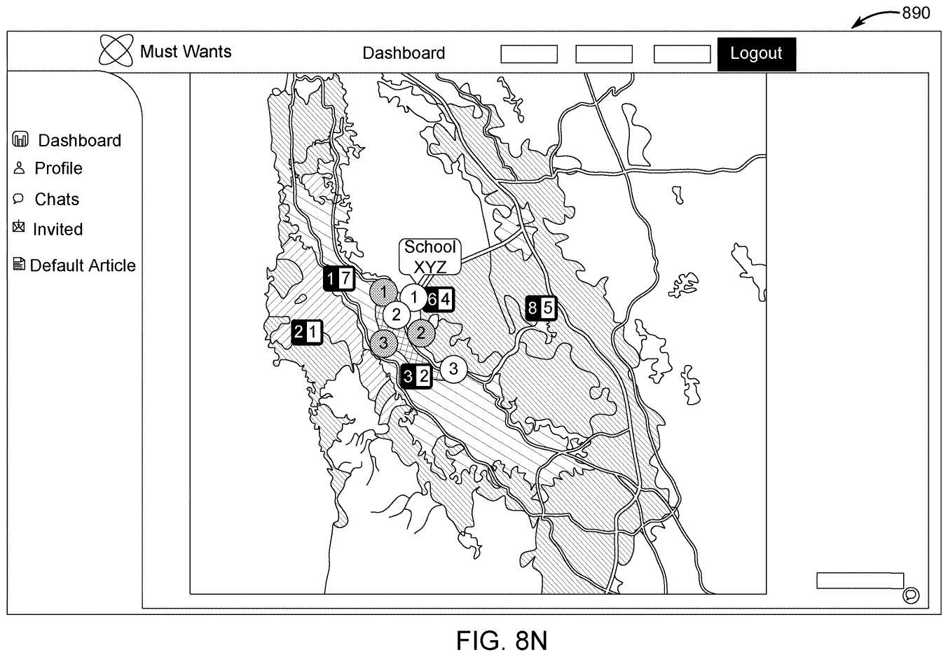

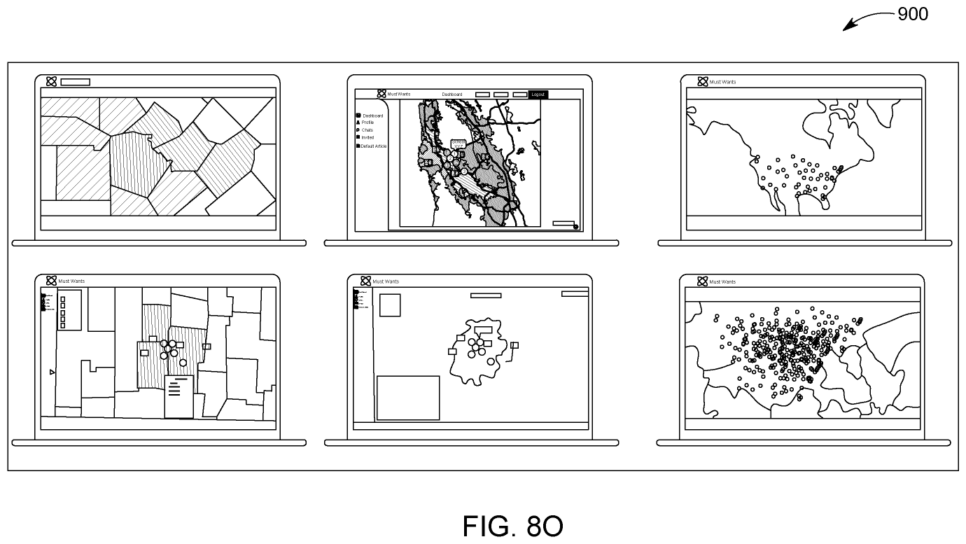

The described techniques are not limited to real-estate applications. For example, these same techniques can be applied to applications for auto or trailer purchases as shown via a few exemplary screenshots in FIGS. 8A-8D. The priorities screens 802, 804 of FIGS. 8A and 8C can receive and display user priorities with respect to various auto or trailer factors, respectively. The individual priorities of these screens may be further configured, in some cases using additional screens, such as shown by way of example in the price screen 806 of FIG. 8D. Using specified and prioritized preferences 406, the system 400, using algorithm(s) 404 and data acquired from selected search engine(s), can generate and display a list of recommendations of the desired product or service, such as shown by way of example in the results screen 808 of FIG. 8C. Those skilled in the art will appreciate that a complete auto-purchase or trailer-purchase system will have many similar features to those described above with respect to real estate systems. Tying into a buyer, collaborator, dealer, and salesperson enhances the communications element of the afore-described embodiments. The ability for buyers, collaborators, and sales representatives to share information enhances communications, ensuring the algorithms provide sufficient data to greatly enhance the organizational structure of the diverse product opportunities presented to the buyers. This reduces confusion concerning the diverse product opportunities, which enhances the buyer's experience and improves decision-making.

### Commuting “Heat” Maps

In certain embodiments, the system provides a visual collaborative commute-mapping capability that integrates user-defined locations, real-time and historical traffic information, and dynamic map-based visualizations. The system may utilize both real-time traffic conditions and historical traffic datasets to generate commute-time estimates for multiple time windows, enabling users to evaluate how commute feasibility varies across different times of day or days of the week.

Users may specify one or more key locations (e.g., workplaces, schools, daycare facilities, or fitness centers) along with desired arrival times or travel windows. In some embodiments, users may further specify preferred transportation modes (e.g., driving, public transit, bicycling, or walking) which the system incorporates when computing route-specific travel-time estimates. The system retrieves commute-time estimates from external data sources and generates color-coded heatmap overlays that visually encode travel-time ranges across geographic regions. Additional locations of interest can be displayed as interactive pins. In some embodiments, users may upload a list of addresses (e.g., through a file-upload interface) and the system can automatically parse, geocode, and add the uploaded addresses to the set of locations of interest displayed on the map.

In certain implementations, users may assign rankings or priority levels to different locations of interest (e.g., preferred schools, gyms, grocery stores, or potential homes), and the system may visually emphasize or annotate such ranked locations within the heatmap display. In certain embodiments, multiple users or collaborators can jointly view, adjust, and evaluate commute-related information within the same interface. Collaborative embodiments may allow multiple participants (e.g., spouses, family members, real-estate agents, or organizational decision-makers) to contribute their own locations of interest, ranked preferences, or commute constraints, with the system generating a unified visualization that reflects the combined inputs of all collaborators. In some embodiments, the commute-mapping functionality may be integrated with home-search or property-listing platforms, allowing users to filter, sort, or compare candidate properties based on commute-time feasibility relative to their selected locations of interest.

As will now be described with respect to FIGS. 8E-8O, some embodiments overlay the identified goods or services (e.g., ranked homes for sale in this example) on top of a map that shows the relevant geography but which is also color-coded to reflect average commuting times or distances associated with multiple points of interest relative to each home. These embodiments can include both multiple points of interest and also one or more collaborators' home selections, as described with respect to earlier embodiments and as shown in FIG. 8E. Such a region may also be referred to herein as a “locus,” representing an area that satisfies one or more commuting-time or commuting-distance thresholds. In such embodiments, the system may concurrently display commute-time information for several homes and several points of interest, enabling comparative evaluation across multiple candidate properties. As will be appreciated by those skilled in the art, a “heat map” or “heatmap” (also sometimes referred to as a “color map”) is typically a 2-dimensional data-visualization mechanism that represents the magnitude of individual values within a dataset as a color, and in these embodiments the geographic regions of the map are visually encoded according to commute-time values relative to one or more points of interest.

For example, as shown in FIGS. 8E and 8F, a commute-time map screen 820 displays average commute times to selected points of interest using different colors (in this case represented by different shadings). In this example, regions 822 on the map which average about 30-45 minutes of commuting time are colored with a first color, regions 824 on the map which average about 15-30 minutes of commuting time are colored with a second color different than the first color, and regions 826 on the map which average 15 minutes or less of commuting time are colored with a third color which is different than the first and second colors. In other embodiments, additional or alternative commute-time ranges and corresponding color assignments may be used, depending on user preferences or system configuration.

As shown in FIG. 8G, users may configure various parameters that influence the generation of the commute-time heatmap. These parameters can include the selection of points of interest to be considered, specification of time-of-day travel windows that may affect traffic conditions, and definition of the commute-time ranges that correspond to different color-coded regions on the map. In other embodiments, the number and boundaries of such commute-time ranges may be user-defined or system-generated, allowing the visualization to adapt to different user preferences or data sources. Additional or alternative input parameters may be provided in other embodiments to tailor the visualization to particular user needs or data sources.

More specifically, FIG. 8G illustrates an input screen 830 that can be displayed on a user's device to enable various input parameters associated with the heat map display to be selected by the user. These inputs can include, for example, inputting desired points of interest 832 to be considered for commuting-time or distance ranges, inputting a time-of-day travel time 834 (which may impact the commute time), and inputting the desired time ranges 836 to be shown as differently color-coded regions on the map. In some embodiments, the input screen may further allow the user to specify a preferred transportation mode (e.g., driving, public transit, bicycling, or walking), which the system incorporates when generating the commute-time heatmap. Those skilled in the art will appreciate that more or fewer inputs can be provided, as well as different inputs, to generate the heat-map display. Note that not all of the steps of the techniques described herein are necessarily performed in a single microprocessor or even in a single module.

Although FIGS. 8E-8G focus on embodiments wherein a single user (or a single user plus his or her collaborators) is informed of average regional commute times relative to multiple points of interest and the locations of goods/services that they are considering, it will be appreciated that commuting heat map like displays according to these embodiments can have other uses. For example, a user could shift the location of a place of employment (e.g., acting as the product or good of interest) and plot every employee's residential location relative to the shifted place of employment to see how it would increase/decrease their commutes to work, as now discussed with respect to the commercial access screen 840 of FIG. 8H and the comparison screen 850 of FIG. 8I. More particularly, FIG. 8H illustrates an example of the commercial access screen 840 through which such relocation-analysis workflows may be initiated. FIG. 8I illustrates an example of a comparison screen 850 in which multiple commute-time visualizations are presented side-by-side, enabling users to compare different candidate locations or scenarios within a unified interface.

In some embodiments, employee residential locations may be provided individually or through an uploaded list of addresses, which the system can automatically parse and geocode for display. See also the employee-directory screen of FIG. 8J, which illustrates additional employee-related inputs that may be used in connection with such commute-impact analyses. Such inputs may include, for example, employee-specific attributes or classifications that allow the system to evaluate commute impacts for different groups or categories of personnel. In some embodiments, users may also review or manage previously saved locations using a saved-locations management screen 870, as illustrated in FIG. 8K, or selectively include or exclude particular addresses from the analysis using the saved locations management screen 870, as shown in FIG. 8L.

The visual collaborative commute-mapping functionality can be applied in a wide variety of contexts. For example, families undergoing military relocations can rapidly evaluate commute feasibility across multiple potential housing areas; homebuyers and renters can identify properties that fall within acceptable travel ranges; and real-estate agents can pre-filter listings based on client-defined commute criteria. Employers and human-resources departments may also use these tools to assist employees with relocation planning or to assess the commute impact of proposed workplace moves. In some embodiments, the system may present multiple commute-time visualizations side-by-side, as illustrated by the comparison screen 850 of FIG. 8I, enabling users to compare different candidate locations, time windows, or collaborator inputs within a unified interface. In some embodiments, customizable overlays (e.g., crime statistics, school locations, or amenity distributions) can be combined with commute-time visualizations to provide a more comprehensive decision-support environment, as illustrated by the overlay screens 880 and 890 of FIGS. 8M and 8N. Additional embodiments may apply the same visualization engine to alternative geospatial datasets, such as environmental, risk-index, or social-media-derived information, as shown in the overlay screen 900 of FIG. 8O.

In some embodiments, the commute-time heatmap visualizations and optional geospatial overlays described herein may be used in conjunction with the ranking algorithms previously discussed. For example, commute-time metrics, proximity-based measures, or overlay-derived attributes (e.g., school quality, crime-rate indices, or environmental-risk scores) may be incorporated as additional preference criteria or weighted factors within the ranking framework. In such embodiments, the system may generate composite ranking values that reflect both user-defined preference scores and commute-feasibility considerations, thereby enabling a unified evaluation of candidate properties, locations of interest, or proposed relocation sites. Similar weighting schemes, preference-binning approaches, or scoring algorithms may be applied to commute-related factors to produce ranked lists or comparative visualizations that integrate both numerical and spatial dimensions of suitability.

According to various embodiments, the boundaries or regions 822 and corresponding boundary outlines can be determined using historically available commute times to calculate the various regions, examples of which are shown in various ones of FIGS. 8E-8O. For example, two-point heat map data, boundaries, and outlines can be generated by combining three datasets:
1) Data About Where people live
   ACS (Census)→population at tract/block group level
   Tables: B01003 (population), B08013 (commute time)
2) Data about where people work
   LODES (LEHD)→origin-destination job flows
   Gives: home census block→workplace block
3) And Data Regarding How long it takes to drive between those places
Routing engine+road network:
   OpenStreetMap+OSRM, Valhalla, or OpenRouteService

These merged data sets will then contain information which can then be used to generate a two point heat map performing the following steps:
1. Pick a job center (lat/lon);
2. Generate isochrones (e.g., 10, 20, 30, 45 min drive);
3. Overlay isochrones onto geographical map:
   Population (ACS) OR
   Workers commuting to that location (LODES)
4. Weight each area (i.e., change color) by:
   travel time and/or;
   population/workers *note also the further description of weighting to derive more complex multi-point (points >2) boundaries, regions, and heatmaps discussed below.

Mathematically, the foregoing can be expressed (using commute times varying over a time window) as follows. First, define:

$$T ( r ; E , h )$$

where h is a historical departure-time bucket, such as weekday 8:00-8:30 AM. Then the region formula becomes

$${R}_{k} ( h ) = \{ r : {τ}_{k - 1} \leq T ( r ; E , h ) < {τ}_{k} \}$$

with boundaries

$$T ( r ; E , h ) = {τ}_{k}$$

A concise formulation of the boundary using the time window is then:

$${B}_{k} = \{ r ∈ G : T ( r ; E ) = {τ}_{k} \}$$

where:
G is the geographic area displayed,
E is the fixed point of employment,
T(r; E) is historical commute time from r to E,
τₖ is a commute-time threshold,
Bₖ is the boundary of a heatmap region.
   And each displayed heatmap region is:

$${R}_{k} = \{ r ∈ G : {τ}_{k - 1} \leq T ( r ; E ) < {τ}_{k} \}$$

Embodiments contemplated here expand on the foregoing two-point heat map, to enable consideration of three or more points of interest as described herein, however the same or similar mathematical approaches can be extended to these further cases. Without over redundance of the embodiments described both above and below. Consider the following modifications (which can be used together or separately). For example, (a) consider using both the historical commute and reverse commute times, and (b) enable the user to weight the commute and reverse commute equally (0.5 each) or unequally (either being >0.5) to shift the displayed heatmap boundary slightly in favor of either the commute or reverse commute (e.g., if a parent absolutely has to pick up their child at 4 pm and can't be late but can drop them off early/more flexibly). Another embodiment contemplates enabling the user to consider not just historical commute times, but also projected commute times associated with a time window during which he or she may desire to rent or own a property. For example, suppose that a Military Service Person is being relocated to a particular base and know that she or he will be stationed there for 3 years and then relocated again. Under that scenario, the user of the platform described in these embodiments may weight the commute/travel times between the three or more points of interest very highly for the next three year window and not care so much about historical numbers or projections beyond three years. Thus heatmaps according to such embodiments might have boundaries which reflect 15/30/45 minute drives that are predicted, e.g., only for the three year window of deployment interest (which would likely present different isochrones as overlays on the geographical maps that didn't weight the drivetime data in this way.

Building on the foregoing examples, the system can be used to evaluate the commute impact of relocating a workplace or other central facility. A user may specify a proposed new location for a place of employment, and the system can plot the residential locations of multiple employees or collaborators relative to that proposed site. The resulting heatmap visualization enables comparative analysis of how commute times would increase or decrease for different individuals or groups, thereby supporting organizational planning and relocation decisions.

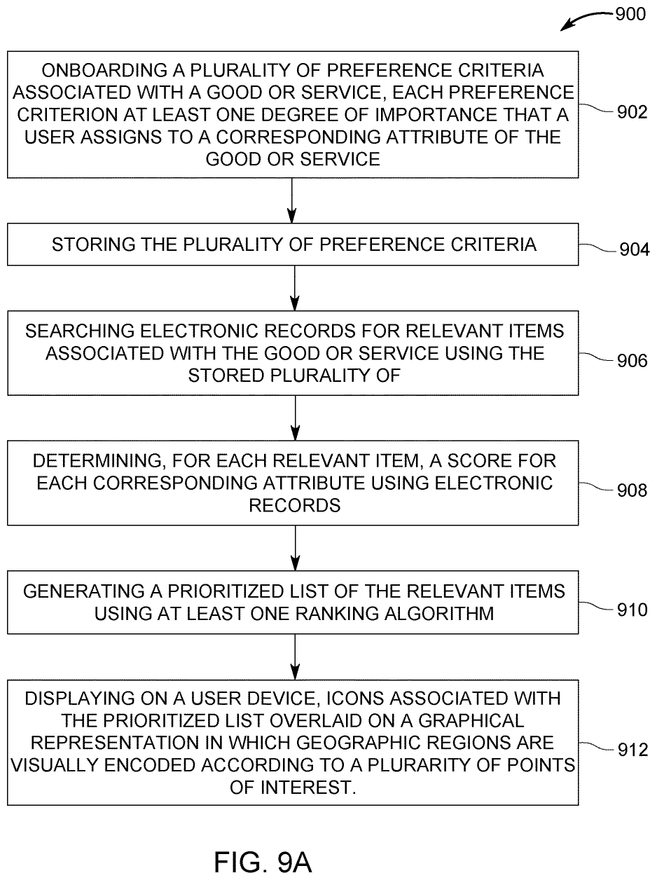

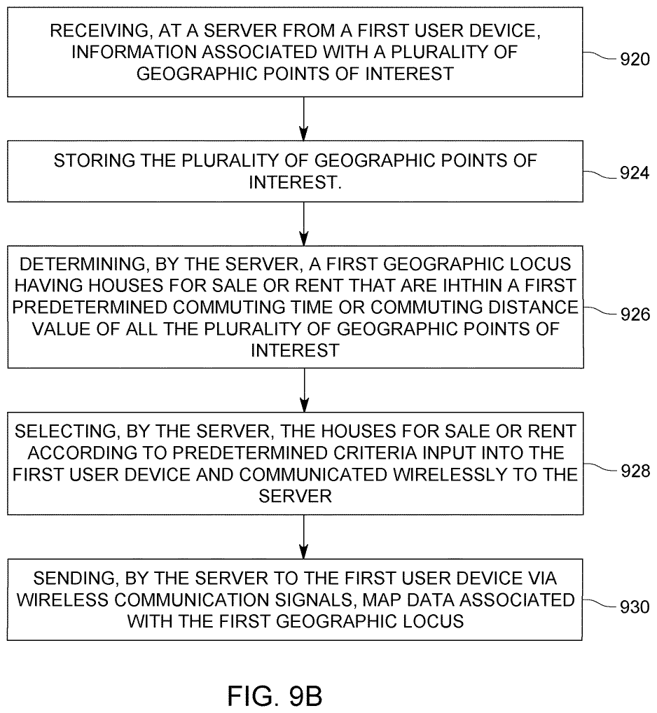

The following figures illustrate example methods that may be performed by the systems and interfaces described above. In particular, FIGS. 9A and 9B depict representative embodiments that may be used to generate prioritized lists of relevant items and to determine geographic loci satisfying user-defined commuting constraints, respectively.

FIG. 9A is a flowchart illustrating an example method 900 consistent with the above-described systems. In step 902, the method begins by onboarding, from a user device, a plurality of preference criteria associated with a good or service, where each preference criterion indicates at least one degree of importance that a user assigns to a corresponding attribute of the good or service. In step 904, the server stores the plurality of preference criteria. In step 906, the server searches electronic records for relevant items associated with the good or service using the stored preference criteria. For each relevant item, the server determines, in step 908, a score for each corresponding attribute using the electronic records. In step 910, the server generates a prioritized list of the relevant items using at least one ranking algorithm. In step 912, icons associated with the prioritized list are displayed on a user device overlaid on a graphical representation in which geographic regions are visually encoded according to commuting-time or commuting-distance values relative to a plurality of points of interest.

FIG. 9B is a flowchart illustrating another example method 920 consistent with the above-described systems. In step 922, the method includes receiving, at a server from a first user device, information associated with a plurality of geographic points of interest. In step 924, the server stores the plurality of geographic points of interest. In step 926, the server determines a first geographic locus having houses for sale or rent that are within a first predetermined commuting-time or commuting-distance value of all of the plurality of geographic points of interest. In step 928, the server selects the houses for sale or rent according to predetermined criteria input into the first user device and communicated wirelessly to the server. In step 930, the server sends map data associated with the first geographic locus to the first user device via wireless communication signals. In step 932, the first user device displays the first geographic locus overlaid on a graphical representation of a region of interest within which the houses for sale or rent are located.

Various differences between visual collaborative commute mapping according to these embodiments, and an existing tool such as the commute time filter provided by Realtor.com® (described above) are discussed below. It will be appreciated that this list is not intended to be exhaustive and that additional distinctions or advantages may be present in other embodiments.

In general, the visual collaborative commute-mapping embodiments described herein differ from the commute-time filter provided by Realtor.com® in several respects. For example, the present embodiments allow users to specify multiple points of interest rather than a single destination, support collaborative inputs from multiple participants, and enable ranking or prioritization of locations of interest. These embodiments further provide dynamic, color-coded heatmaps that can be configured across multiple time windows, transportation modes, and user-defined commute-time ranges. Additional capabilities include the ability to upload lists of addresses, visualize multiple candidate properties simultaneously, and integrate optional geospatial overlays such as school boundaries or crime-rate distributions. These and other distinctions enable a more flexible and comprehensive commute-evaluation workflow than the single-destination commute-time filter offered by Realtor.com®.

In additional embodiments, the commute-time heatmap can be supplemented with other geospatial data layers to assist users in evaluating broader lifestyle or risk-related factors. These optional overlays can include, for example, school-district boundaries, crime-rate distributions, walkability indices, FEMA flood-risk zones, housing-market statistics, and other publicly or commercially available datasets. When enabled, these layers can be rendered concurrently with the commute-time visualization, allowing users to assess multiple dimensions of geographic suitability within a unified, map-based interface.

Additionally, in some embodiments, the non-limiting terms client device and user device or equipment is used, and they refer to any type of wireline devices or wireless devices communicating with a network node in a cellular or mobile communication system over a radio interface. Examples of client devices or user devices are target devices, device-to-device (D2D) user equipments (UEs,) proximity-based service (ProSe) UEs, machine type UEs or UEs capable of machine to machine communication (aka category 0 UEs, low cost and/or low complexity UEs), PDAs, iPADs, tablets, mobile terminals, smart phones, laptop embedded equipment (LEE), laptop mounted equipment (LME), USB dongles, wireless devices etc. However, such devices can also include virtual reality equipments, including VR goggles, headsets, glasses, and the like.

Additionally, in some embodiments, the non-limiting term server refers to any type of computing system, processing node, or network-accessible computational resource capable of executing instructions, storing data, and communicating with one or more user devices or client devices. A server may include a single physical machine, a distributed set of machines, a cloud-based compute instance, a virtualized processing environment, an edge-computing node, or any combination thereof. In various embodiments, the server may include one or more processors, memory structures, databases, storage systems, communication interfaces, or specialized hardware accelerators. The server may operate within a data center, a cloud platform, a private network, or a hybrid environment, and may communicate with user devices over wired or wireless communication links, including cellular, Wi-Fi, satellite, or other network technologies.

It should be understood that this description is not intended to limit the invention. On the contrary, the embodiments are intended to cover alternatives, modifications, and equivalents, which are included in the spirit and scope of the invention. Further, in the detailed description of the embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A system, comprising:
a user device including an interface configured to receive information associated with a plurality of preference criteria for a good or service, each preference criterion indicating at least one degree of importance that a user assigns to a corresponding attribute of the good or service; and
a server configured to store and process the plurality of preference criteria and to search electronic records for relevant items using the stored plurality of preference criteria;
wherein the server is further configured to determine, for each relevant item, a score for each corresponding attribute based on the electronic records, and to generate a prioritized list of the relevant items using at least one ranking algorithm;
wherein the prioritized list is generated based at least in part on a composite score for each relevant item; and
wherein icons associated with the prioritized list are displayed on the user device overlaid on a graphical representation in which geographic regions are visually encoded according to commuting time or distance values relative to a plurality of points of interest.

2. The system of claim 1, wherein the server comprises a central server; and
wherein the user device comprises a wireless communication device configured to receive the prioritized list from the central server for display thereon.

3. The system of claim 1, wherein the good or service comprises real estate properties for sale, the relevant items comprise real estate properties each having a respective location, the corresponding attributes include number of bedrooms, and the at least one degree of importance includes a must-have level indicating a required attribute and a want level indicating a desired attribute.

4. The system of claim 3, wherein the plurality of preference criteria entered by the user indicates that the user must have three bedrooms and wants four bedrooms, and wherein the at least one ranking algorithm prioritizes a first relevant item in the prioritized list having four bedrooms higher than a second relevant item that has three bedrooms when the first and second relevant items have a same score for others of the plurality of preference criteria.

5. The system of claim 1, wherein entering the plurality of preference criteria further comprises entering preference criteria from a primary user and one or more collaborators of the primary user.

6. The system of claim 5, wherein the ranking algorithm uses average scores associated with the preference criteria onboarded for the one or more collaborators for corresponding attributes having a same degree of importance assigned thereto, the average scores being weighted by a factor that is different for different degrees of importance to determine where each relevant item is ranked in the prioritized list.

7. The system of claim 6, wherein weights used by the ranking algorithm for the average scores generated using the corresponding attributes associated with the primary user's plurality of preference criteria are different from weights used by the ranking algorithm for the average scores generated using the corresponding attributes associated with the one or more collaborators' plurality of preference criteria.

8. The system of claim 7, wherein the primary user selects a weighting level for each of the one or more collaborators.

9. The system of claim 1, wherein the prioritized list indicates information about each relevant item including how many of the preference criteria are satisfied by each relevant item.

10. The system of claim 1, wherein the system determines a current location of the user device and sends information associated with a map display to the user device, and wherein the user device displays the map including icons associated with its current location and the locations of items on the prioritized list.

11. A system, comprising:
a first user device including an interface configured to receive information associated with a plurality of geographic points of interest; and
a server configured to receive the information from the first user device and to store and process the plurality of geographic points of interest to determine a first geographic locus having houses for sale or rent that are within a first predetermined commuting time or distance value of all of the plurality of geographic points of interests;
wherein the houses for sale or rent are selected according to predetermined criteria input into the first user device and communicated wirelessly to the server;
wherein the server communicates map data associated with the first geographic locus to the user device via wireless communication signals;
wherein the first geographic locus is displayed on the user device overlaid on a graphical representation of a region of interest within which the houses for sale or rent are located.

12. The system of claim 11, wherein the plurality of geographic points of interest include a first point of interest associated with a school and a second point of interest associated with a workplace.

13. The system of claim 12, wherein the server is further configured to determine a second geographic locus having houses for sale or rent that are within a second predetermined commuting time or distance value of all of the plurality of geographic points of interest, said second commuting time or distance being greater than said first commuting time or distance.

14. The system of claim 13, wherein the server communicates data associated with the second geographic locus to the user device and wherein the user device displays the first geographic locus using a first color and the second geographic locus using a second color.

15. The system of claim 14, wherein houses for sale or rent that are identified by one or more collaborators of a user using the first user device have icons which are overlaid on the first geographic locus and/or the second geographic locus on the display of the user device.

16. A method, comprising:
onboarding a plurality of preference criteria associated with a good or service, each preference criterion indicating at least one degree of importance that a user assigns to a corresponding attribute of the good or service;
storing, by a server, the plurality of preference criteria;
searching electronic records for relevant items associated with the good or service using the stored plurality of preference criteria;
determining, for each relevant item, a score for each corresponding attribute using the electronic records;
generating a prioritized list of the relevant items using at least one ranking algorithm; and
displaying, on a user device, icons associated with the prioritized list overlaid on a graphical representation in which geographic regions are visually encoded according to commuting time or distance values relative to a plurality of points of interest.

17. The method of claim 16, wherein the user device comprises a wireless communication device configured to receive the prioritized list from the server.

18. The method of claim 16, wherein the good or service is real estate properties for sale, the relevant items comprise real estate properties each having a respective location, the corresponding attributes include number of bedrooms, and at least one degree of importance includes a must-have level indicating a required attribute and a want level indicating a desired attribute.

19. The method of claim 18, wherein the plurality of preference criteria onboarded by a user indicates that the user must have three bedrooms and wants four bedrooms, and wherein the at least one ranking algorithm prioritizes a first relevant item in the prioritized list having four bedrooms higher than a second relevant item that has three bedrooms when the first and second relevant items have a same score for others of the plurality of preference criteria.

20. The method of claim 16, wherein the step of onboarding further comprises onboarding the plurality of preference criteria associated with the good or service from a primary user and one or more collaborators of the primary user.

21. The method of claim 20, wherein the ranking algorithm uses average scores associated with the preference criteria onboarded for the one or more collaborators for corresponding attributes having a same degree of importance assigned thereto, the average scores being weighted by a factor that is different for different degrees of importance to determine where each relevant item is ranked in the prioritized list.

22. The method of claim 20, wherein weights used by the ranking algorithm for the average scores generated using the corresponding attributes associated with the primary user's plurality of preference criteria are different from weights used by the ranking algorithm for the average scores generated using the corresponding attributes associated with the one or more collaborators' plurality of preference criteria.

23. The method of claim 22, wherein the primary user selects a weighting level for each of the one or more collaborators.

24. The method of claim 16, wherein the prioritized list indicates information about each relevant item including how many of the preference criteria are satisfied by each relevant item.

25. The method of claim 16, further comprising:
determining a current location of the user device;
and sending information associated with a map display.

26. A method, comprising:
receiving, at a server from a first user device, information associated with a plurality of geographic points of interest;
storing, by the server, the plurality of geographic points of interest;
determining, by the server, a first geographic locus having houses for sale or rent that are within a first predetermined commuting time or distance value of all of the plurality of geographic points of interest;
selecting, by the server, the houses for sale or rent according to predetermined criteria input into the first user device and communicated wirelessly to the server;
sending, by the server to the first user device via wireless communication signals, map data associated with the first geographic locus; and
displaying, on the first user device, the first geographic locus overlaid on a graphical representation of a region of interest within which the houses for sale or rent are located.

27. The method of claim 26, wherein the plurality of geographic points of interest include a first point of interest associated with a school and a second point of interest associated with a workplace.

28. The method of claim 27, further comprising determining, by the server, a second geographic locus having houses for sale or rent that are within a second predetermined commuting time or distance of all of the plurality of geographic points of interest, the second predetermined commuting time or distance value being greater than the first predetermined commuting time or distance.

29. The method of claim 28, further comprising:
sending, by the server, data associated with the second geographic locus to the first user device; and
displaying, on the first user device, the first geographic locus using a first color and the second geographic locus using a second color.

30. The method of claim 29, further comprising displaying, on the first user device, icons associated with houses for sale or rent that are identified by one or more collaborators of a user, the icons being overlaid on the first geographic locus and/or the second geographic locus.
